(19) United States
(12) Patent Application Publication
(10) Pub. No.: US 2021/0198574 A1
(43) Pub. Date: Jul. 1, 2021

(54) COMPOSITION, RETARDATION FILM, AND METHOD FOR PRODUCING RETARDATION FILM

(71) Applicant: ZEON CORPORATION, Chiyoda-ku, Tokyo (JP)

(72) Inventors: Wataru NAKANO, Tokyo (JP); Sogo KOMOTO, Tokyo (JP); Manabu ITO, Tokyo (JP); Yasunori II, Tokyo (JP)

(73) Assignee: ZEON CORPORATION, Chiyoda-ku, Tokyo (JP)

(21) Appl. No.: 16/963,250

(22) PCT Filed: Jan. 21, 2019
(86) PCT No.: PCT/JP2019/001725

§ 371 Date: Jul. 20, 2020

(30) Foreign Application Priority Data
Jan. 31, 2018 (JP) 2018-015040

(51) Int. Cl. C09K 19/04; C08F 222/10; C08F 2/50; C08F 2/40

(52) U.S. Cl. CPC C09K 19/04; C08F 222/102; C08F 222/103; C09K 2019/0448; C08F 2/40; C09K 2219/03; C08F 2/50

(57) ABSTRACT

A composition includes a polymerizable liquid crystal compound (A), a photopolymerization initiator (B), and a crosslinking agent (C), and satisfies:

|λₐ₁−λ_{b1}|≤20 nm (i), and

λ_{c1}≤250 nm (ii),

where λₐ₁ represents a wavelength of an absorption local maximum that is the longest one of wavelengths of absorption local maxima in a light absorption spectrum of from 200 nm to 500 nm of the polymerizable liquid crystal compound (A), λ_{b1} represents a wavelength of an absorption local maximum that is the longest one of wavelengths of absorption local maxima in a light absorption spectrum of from 200 nm to 500 nm of the photopolymerization initiator (B), and λ_{c1} represents a wavelength of at least one absorption local maximum in a light absorption spectrum of from 200 nm to 500 nm of the crosslinking agent (C)).

### FIELD

The present invention relates to a composition, a phase difference film, and a method for producing the phase difference film.

### BACKGROUND

As a material for producing a phase difference film, a composition including a polymerizable liquid crystal compound and a photopolymerization initiator has been developed (Patent Literatures 1 to 4). A phase difference film is produced by applying the composition onto, for example, a substrate film to form a composition layer, and irradiating the composition with certain light thereby to cure the polymerizable liquid crystal compound.

### CITATION LIST

### Patent Literature

Patent Literature 1: International Publication No. 2014/065243 (corresponding publication: U.S. Patent Application Publication No. 2015/0277010)

Patent Literature 2: International Publication No. 2014/069515 (corresponding publication: U.S. Patent Application Publication No. 2015/0285979)

Patent Literature 3: Japanese Patent Application Laid-Open No. 2009-098664 A

Patent Literature 4: Japanese Patent Application Laid-Open No. 2017-027056 A (corresponding publication: U.S. Patent Application Publication No. 2017/0022418)

### SUMMARY

### Technical Problem

The phase difference film is provided to an image display apparatus or the like, and sometimes used in a high temperature location such as in a vehicle interior. Therefore, the phase difference film is preferably unlikely to change in optical properties even when exposed to high temperature, and particularly preferably shows a small absolute value of a change rate of a retardation Re.

Therefore, there is a demand for a phase difference film that shows a small absolute value of a change rate of a retardation Re before and after a thermal durability test, and a composition with which such a phase difference film can be produced.

### Solution to Problem

The present inventors found that when a difference in an absorption local maximum wavelength between a polymerizable liquid crystal compound and a photopolymerization initiator exceeds 20 nm, like technologies of Patent Literatures 3 and 4, the thermal durability of a phase difference film obtained by curing the composition is insufficient, and a change of a retardation Re in a thermal durability test is large.

On the basis of this finding, the inventors of the present invention intensively conducted research for solving the aforementioned problem. As a result, the inventors have unexpectedly found that the aforementioned problem can be solved with a composition that includes a polymerizable liquid crystal compound, a photopolymerization initiator, and a crosslinking agent, in which an absolute value of a difference in a prescribed absorption local maximum wavelength between the polymerizable liquid crystal compound and the photopolymerization initiator is 20 nm or less. Thus, the present invention has been accomplished. That is, the present invention provides the following.
<1> A composition comprising a polymerizable liquid crystal compound (A), a photopolymerization initiator (B), and a crosslinking agent (C),

the composition satisfying the following formulae (i) and (ii):

|λₐ₁−λ_{b1}|≤20 nm (i), and

λ_{c1}≤250 nm (ii)

(in the formulae,

λₐ₁ represents a wavelength of an absorption local maximum that is the longest one of wavelengths of absorption local maxima in a light absorption spectrum of 200 nm or more and 500 nm or less of the polymerizable liquid crystal compound (A),

λ_{b1} represents a wavelength of an absorption local maximum that is the longest one of wavelengths of absorption local maxima in a light absorption spectrum of 200 nm or more and 500 nm or less of the photopolymerization initiator (B), and

λ_{c1} represents a wavelength of at least one absorption local maximum in a light absorption spectrum of 200 nm or more and 500 nm or less of the crosslinking agent (C)).
<2> The composition according to <1>, further satisfying the following formulae (iii) and (iv):

300 nm≤λₐ₁≤355 nm (iii), and

5000 cm²/mol≤Aₐ≤25000 cm²/mol (iv)

(in the formulae,

λₐ₁ has the same meaning as the above, and

Aₐ represents an average molar absorption coefficient of the polymerizable liquid crystal compound (A) in a range of 300 nm or more and 355 nm or less).
<3> The composition according to <1> or <2>, further satisfying the following formulae (v) and (vi):

300 nm≤λ_{b1}≤355 nm (v), and

10000 cm²/mol≤A_{b}≤25000 cm²/mol (iv)

(in the formulae,

λ_{b1} has the same meaning as the above, and

A_{b} represents an average molar absorption coefficient of the photopolymerization initiator (B) in a range of 300 nm or more and 355 nm or less).
<4> The composition according to any one of <1> to <3>, further satisfying the following formula (vii):

A_{c}<A, and A_{c}<A_{b} (vii)

(in the formula,

Aₐ represents an average molar absorption coefficient (cm²/mol) of the polymerizable liquid crystal compound (A) in a range of 300 nm or more and 355 nm or less,

A_{b} represents an average molar absorption coefficient (cm²/mol) of the photopolymerization initiator (B) in a range of 300 nm or more and 355 nm or less, and

A_{c} represents an average molar absorption coefficient (cm²/mol) of the crosslinking agent (C) in a range of 300 nm or more and 355 nm or less).
<5> The composition according to any one of <1> to <4>, wherein the polymerizable liquid crystal compound (A) is a compound represented by the following formula (I):

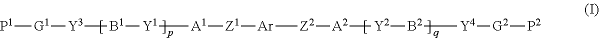

(in the formula (I),

Ar is a group represented by any of the following formulae (II-1) to (II-7),

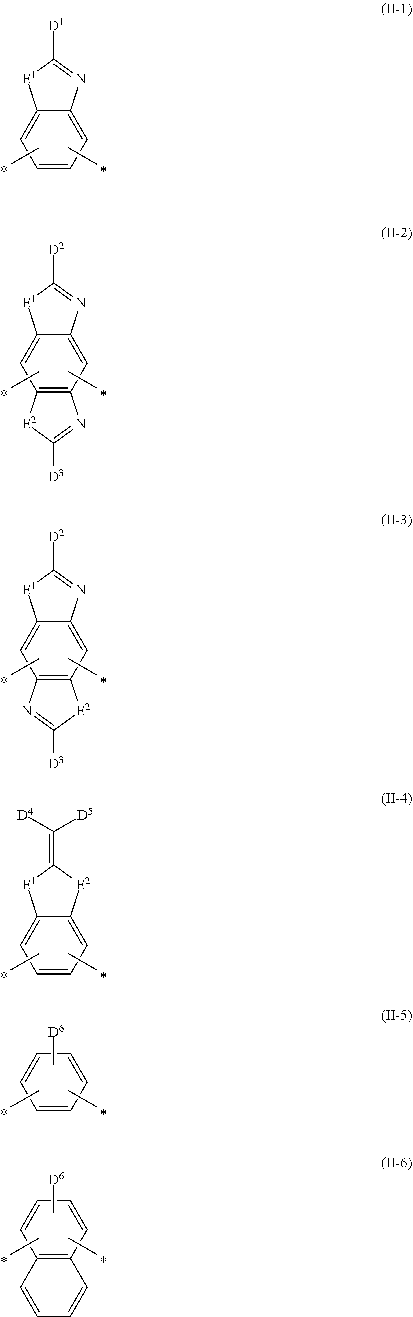

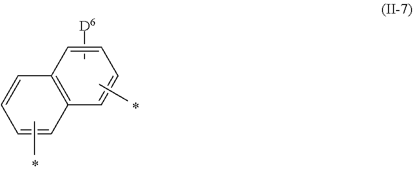

(in the formulae (II-1) to (II-7),

the symbol “*” represents a position for bonding with Z¹ or Z²,

each of E¹ and E² independently represents a group selected from the group consisting of —CR¹¹R¹²—, —S—, —NR¹¹—, —CO—, and —O—, and each of R¹¹ and R¹² independently represents a hydrogen atom or an alkyl group of 1 to 4 carbon atoms,

each of D¹ to D³ independently represents an aromatic hydrocarbon ring group optionally having a substituent or an aromatic heterocyclic ring group optionally having a substituent,

each of D⁴ to D⁵ independently represents a non-cyclic group optionally having a substituent, and D⁴ and D⁵ may together form a ring,

D⁶ represents a group selected from the group consisting of —C(R^{f})═N—N(R^{g})R^{h}, —C(R^{f})═N—N═C(R^{g})R^{h}, and —C(R^{f})═N—N═Rⁱ, R^{f} represents a group selected from the group consisting of a hydrogen atom and an alkyl group of 1 to 6 carbon atoms, R^{g} represents a group selected from the group consisting of a hydrogen atom and an organic group of 1 to 30 carbon atoms optionally having a substituent, R^{h} represents an organic group having one or more aromatic rings selected from the group consisting of an aromatic hydrocarbon ring of 6 to 30 carbon atoms and an aromatic heterocyclic ring of 2 to 30 carbon atoms, and Rⁱ represents an organic group having one or more aromatic rings selected from the group consisting of an aromatic hydrocarbon ring of 6 to 30 carbon atoms and an aromatic heterocyclic ring of 2 to 30 carbon atoms),

each of Z¹ and Z² independently represents one selected from the group consisting of a single bond, —O—, —O—CH₂—, —CH₂—O—, —O—CH₂—CH₂—, —CH₂—CH₂—O—, —C(═O)—O—, —O—C(═O)—, —C(═O)—S—, —S—C(═O)—, —NR²¹—C(═O)—, —C(═O)—NR²¹—, —CF₂—O—, —O—CF₂—, —CH₂—CH₂—, —CF₂—CF₂—, —O—CH₂—CH₂—O—, —CH═CH—C(═O)—O—, —O—C(═O)—CH═CH—, —CH₂—C(═O)—O—, —O—C(═O)—CH₂—, —CH₂—O—C(═O)—, —C(═O)—O—CH₂—, —CH₂—CH₂—C(═O)—O—, —O—C(═O)—CH₂—CH₂—, —CH₂—CH₂—O—C(═O)—, —C(═O)—O—CH₂—CH₂—, —CH═CH—, —N═CH—, —CH═N—, —N═C(CH₃)—, —C(CH₃)═N—, —N═N—, and —C≡C—, and each of R²¹'s independently represents a hydrogen atom or an alkyl group of 1 to 6 carbon atoms,

each of A¹, A², B¹, and B² independently represents a group selected from the group consisting of a cyclic aliphatic group optionally having a substituent, and an aromatic group optionally having a substituent,

each of Y¹ to Y⁴ independently represents one selected from the group consisting of a single bond, —O—, —C(═O)—, —C(═O)—O—, —O—C(═O)—, —NR²²—C(═O)—, —C(═O)—NR²²—, —O—C(═O)—O—, —NR²²—C(═O)—O—, —O—C(═O)—NR²²—, and —NR²²—C(═O)—NR²³—, and each of R²² and R²³ independently represents a hydrogen atom or an alkyl group of 1 to 6 carbon atoms,

each of G¹ and G² independently represents an organic group selected from the group consisting of an aliphatic hydrocarbon group of 1 to 20 carbon atoms; and a group having a structure obtained by substituting one or more of methylene groups (—CH₂—) contained in an aliphatic hydrocarbon group of 3 to 20 carbon atoms with —O— or —C(═O)—, wherein a hydrogen atom contained in the organic group of G¹ and G² may be substituted with an alkyl group of 1 to 5 carbon atoms, an alkoxy group of 1 to 5 carbon atoms, or a halogen atom, provided that methylene groups (—CH₂—) at both ends of G¹ and G² are never substituted with —O— or —C(═O)—,

each of P¹ and P² independently represents a polymerizable functional group, and

each of p and q independently represents 0 or 1).
<6> The composition according to any one of <1> to <5>, wherein the polymerizable liquid crystal compound (A) is a polymerizable liquid crystal compound having a reverse wavelength dispersion property.
<7> The composition according to any one of <1> to <6>, wherein the crosslinking agent (C) is a bifunctional monomer.
<8> The composition according to any one of <1> to <7>, wherein the crosslinking agent (C) is a compound having an alicyclic structure.
<9> The composition according to any one of <1> to <8>, wherein the photopolymerization initiator (B) is an O-acyloxime compound.
<10> A phase difference film formed of a cured product of the composition according to <1>, wherein a retardation Re at 590 nm thereof is more than 100 nm and less than 180 nm.
<11> The phase difference film according to <10>, satisfying the following formula (viii):

|Δn0−Δn1|<0.025 nm (viii)

(in the formula,

Δn1 represents a birefringence at 590 nm of the phase difference film, and

Δn0 represents a birefringence at 590 nm of a film formed of a cured product of a composition (X₀) that is a composition omitting the crosslinking agent (C) from the composition according to <1>.
<12> A method for producing a phase difference film formed of a cured product of the composition according to any one of <1> to <9>, comprising the following steps (1) to (3) in this order:

step (1): a step of drying a composition layer formed of the composition according to any one of <1> to <9>;

step (2): a step of irradiating the dried composition layer with ultraviolet light to obtain a cured layer; and

step (3): a step of subjecting the cured layer to a heating treatment.
<13> The method for producing a phase difference film according to <12>, wherein the step (2) includes irradiating with ultraviolet light by a mercury lamp.

### Advantageous Effects of Invention

According to the present invention, there can be provided a phase difference film that shows a small absolute value of a change rate of a retardation Re before and after a thermal durability test, and a composition with which such a phase difference film can be produced.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a retardation of a certain layer refers to an in-plane retardation Re, unless otherwise specified. The in-plane retardation Re is a value represented by Re═(nx−ny)×d, unless otherwise specified.

In the following description, a birefringence Δn of a certain layer is a value represented by Δn=nx−ny, unless otherwise specified. The birefringence Δn is usually a value (Re/d) obtained by dividing the in-plane retardation Re by d.

Herein, nx represents a refractive index in a direction in which the maximum refractive index is given among directions perpendicular to the thickness direction of the layer (in-plane directions), ny represents a refractive index in a direction, among the above-mentioned in-plane directions of the layer, orthogonal to the direction giving nx, and d represents the thickness of the layer. The measurement wavelength of the retardation is 590 nm, unless otherwise specified.

In the following description, a “reverse wavelength dispersion property” refers to a property in which the in-plane retardation Re(450) at a wavelength of 450 nm, the in-plane retardation Re(550) at a wavelength of 550 nm, and the in-plane retardation Re(650) at a wavelength of 650 nm satisfy the following formulae (1) and (2), unless otherwise specified.

Re(450)/Re(550)<1.00 (1)

Re(650)/Re(550)>1.00 (2)

“Ultraviolet light” means light having a wavelength of 1 nm or more and 400 nm or less.

In the following description, a “1/4λ plate” includes not only a rigid member but also a flexible member such as a resin film.

A direction of a constituent element being “parallel” or “perpendicular” may allow an error within the range of not impairing the advantageous effects of the present invention, for example, within a range of ±5°, unless otherwise specified.

In the following description, an absorption local maximum in a light absorption spectrum of 200 nm or more and 500 nm or less usually has a maximum absorbance in the light absorption spectrum of 200 nm or more and 500 nm or less, or an absorbance of 10% or more of the maximum absorbance.

In the following description, the term “(meth)acryloyl” encompasses “methacryloyl”, “acryloyl”, and a combination thereof, and the term “(meth)acrylate” encompasses “methacrylate”, “acrylate”, and a combination thereof.

[1. Composition]

The composition of the present invention includes a polymerizable liquid crystal compound (A), a photopolymerization initiator (B), and a crosslinking agent (C), and satisfies the following formulae (i) and (ii).

|λₐ₁−λ_{b1}|≤20 nm (i)

λ_{c1}≤250 nm (ii)

In the aforementioned formulae,

λₐ₁ represents a wavelength of an absorption local maximum that is the longest wavelength in a light absorption spectrum of 200 nm or more and 500 nm or less of the polymerizable liquid crystal compound (A),

λ_{b1} represents a wavelength of an absorption local maximum that is the longest wavelength in a light absorption spectrum of 200 nm or more and 500 nm or less of the photopolymerization initiator (B), and

λ_{c1} represents a wavelength of at least one absorption local maximum in a light absorption spectrum of 200 nm or more and 500 nm or less of the crosslinking agent (C).

[Polymerizable Liquid Crystal Compound (A)]

A liquid crystal compound is a compound that is capable of exhibiting a liquid crystal phase when it is included in a composition and oriented. A polymerizable liquid crystal compound is a liquid crystal compound that is capable of being polymerized in a composition in a state in which the liquid crystal phase is exhibited, to become a polymer in which the molecular orientation in the liquid crystal phase is maintained.

The molecular weight of the polymerizable liquid crystal compound (A) is preferably 300 or more, more preferably 500 or more, and particularly preferably 800 or more, and is preferably 2000 or less, more preferably 1700 or less, and particularly preferably 1500 or less. When the polymerizable liquid crystal compound (A) having a molecular weight in such a range is used, the composition can have a favorable coating property.

The composition of the present invention may contain one type of polymerizable liquid crystal compound (A) solely or a combination of two or more types thereof at any ratio.

The polymerizable liquid crystal compound (A) may be a polymerizable liquid crystal compound having a reverse wavelength dispersion property, and is preferably a polymerizable liquid crystal compound having a reverse wavelength dispersion property. Herein, the polymerizable liquid crystal compound having a reverse wavelength dispersion property refers to a polymerizable liquid crystal compound which provides a polymer exhibiting a reverse wavelength dispersion property when the compound is homogeneously oriented and polymerized to be a polymer. By using the polymerizable liquid crystal compound having a reverse wavelength dispersion property as part or all of the polymerizable liquid crystal compound (A) included in the composition, a phase difference film having a reverse wavelength dispersion property can be easily obtained.

The polymerizable liquid crystal compound (A) is preferably a compound represented by the following formula (I). The compound represented by the formula (I) can exhibit a reverse dispersion property.

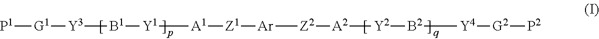

In the formula (I), Ar is a group represented by any of the following formulae (II-1) to (II-7). In the formulae (II-1) to (II-7), the symbol “*” represents a position for bonding with Z¹ or Z².

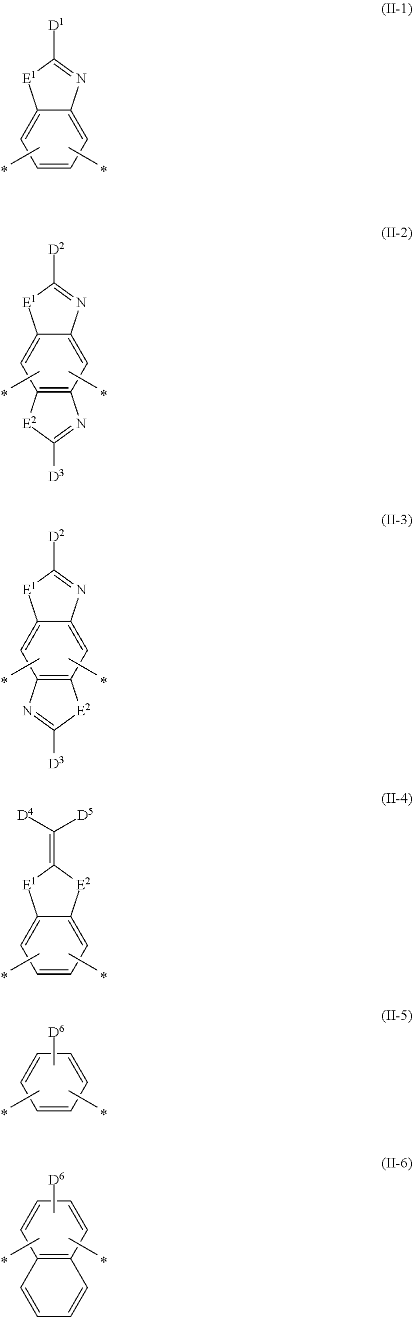

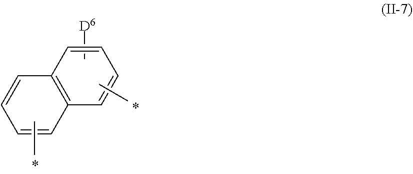

In the aforementioned formulae (II-1) to (II-7), each of E¹ and E² independently represents a group selected from the group consisting of —CR¹¹R¹²—, —S—, —NR¹¹—, —CO—, and —O—. each of R¹¹ and R¹² independently represents a hydrogen atom or an alkyl group of 1 to 4 carbon atoms.

Among these, it is preferable that each of E¹ and E² is independently —S—.

In the aforementioned formulae (II-1) to (II-7), each of D¹ to D³ independently represents an aromatic hydrocarbon ring group optionally having a substituent or an aromatic heterocyclic ring group optionally having a substituent. Usually, the numbers of carbon atoms of the respective groups represented by each of D¹ to D³ (including the number of carbon atoms in the substituent) is independently 2 to 100.

The number of carbon atoms of the aromatic hydrocarbon ring group in D¹ to D³ is preferably 6 to 30. Examples of the aromatic hydrocarbon ring group of 6 to 30 carbon atoms in D¹ to D³ may include a phenyl group and a naphthyl group. Among these, a phenyl group is more preferable as the aromatic hydrocarbon ring group.

Examples of the substituents that the aromatic hydrocarbon ring group in D¹ to D³ may have may include a halogen atom such as a fluorine atom and a chlorine atom; a cyano group; an alkyl group of 1 to 6 carbon atoms such as a methyl group, an ethyl group, and a propyl group; an alkenyl group of 2 to 6 carbon atoms such as a vinyl group and an allyl group; an alkyl halide group of 1 to 6 carbon atoms such as a trifluoromethyl group; an N,N-dialkylamino group of 1 to 12 carbon atoms such as a dimethylamino group; an alkoxy group of 1 to 6 carbon atoms such as a methoxy group, an ethoxy group, and an isopropoxy group; a nitro group; —OCF₃; —C(═O)—R^{b}; —O—C(═O)—R^{b}; —C(═O)—O—R^{b}; and —SO₂R^{a}. The number of substituents may be one or plural. The plurality of substituents may be the same as or different from one another.

R^{a} represents a group selected from the group consisting of an alkyl group of 1 to 6 carbon atoms; and an aromatic hydrocarbon ring group of 6 to 20 carbon atoms optionally having an alkyl group of 1 to 6 carbon atoms or an alkoxy group of 1 to 6 carbon atoms as a substituent.

R^{b} represents a group selected from the group consisting of an alkyl group of 1 to 20 carbon atoms optionally having a substituent; an alkenyl group of 2 to 20 carbon atoms optionally having a substituent; a cycloalkyl group of 3 to 12 carbon atoms optionally having a substituent; and an aromatic hydrocarbon ring group of 6 to 12 carbon atoms optionally having a substituent.

The number of carbon atoms of the alkyl group of 1 to 20 carbon atoms in R^{b} is preferably 1 to 12, and more preferably 4 to 10. Examples of the alkyl group of 1 to 20 carbon atoms in R^{b} may include a methyl group, an ethyl group, an n-propyl group, an isopropyl group, an n-butyl group, an isobutyl group, a 1-methylpentyl group, a 1-ethylpentyl group, a sec-butyl group, a t-butyl group, an n-pentyl group, an isopentyl group, a neopentyl group, an n-hexyl group, an isohexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, and an n-icosyl group.

Examples of the substituent that the alkyl group of 1 to 20 carbon atoms in R^{b} may have may include a halogen atom such as a fluorine atom and a chlorine atom; a cyano group; an N,N-dialkylamino group of 2 to 12 carbon atoms such as a dimethylamino group; an alkoxy group of 1 to 20 carbon atoms such as a methoxy group, an ethoxy group, an isopropoxy group, and a butoxy group; an alkoxy group of 1 to 12 carbon atoms substituted by an alkoxy group of 1 to 12 carbon atoms such as a methoxymethoxy group and an methoxyethoxy group;

a nitro group; an aromatic hydrocarbon ring group of 6 to 20 carbon atoms such as a phenyl group and a naphthyl group; an aromatic heterocyclic ring group of 2 to 20 carbon atoms such as a triazolyl group, a pyrrolyl group, a furanyl group, a thienyl group, a triazolyl group, and a benzothiazol-2-ylthio group; a cycloalkyl group of 3 to 8 carbon atoms such as a cyclopropyl group, a cyclopentyl group, and a cyclohexyl group; a cycloalkyloxy group of 3 to 8 carbon atoms such as a cyclopentyloxy and a cyclohexyloxy group;

a cyclic ether group of 2 to 12 carbon atoms such as a tetrahydrofuranyl group, a tetrahydropyranyl group, a dioxolanyl group, and a dioxanyl group; an aryloxy group of 6 to 14 carbon atoms such as a phenoxy group and a naphthoxy group; a fluoroalkyl group of 1 to 12 carbon atoms in which one or more hydrogen atoms have been substituted with a fluorine atom such as a trifluoromethyl group, a pentafluoroethyl group, and —CH₂CF₃; a benzofuryl group; a benzopyranyl group; a benzodioxolyl group; and a benzodioxanyl group. The number of substituents may be one or plural. The plurality of substituents may be the same as or different from one another.

The number of carbon atoms of the alkenyl group of 2 to 20 carbon atoms in R^{b} is preferably 2 to 12. Examples of the alkenyl group of 2 to 20 carbon atoms in R^{b} may include a vinyl group, a propenyl group, an isopropenyl group, a butenyl group, an isobutenyl group, a pentenyl group, a hexenyl group, a heptenyl group, an octenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadenyl group, and an icocenyl group.

Examples of the substituent that the alkenyl group of 2 to 20 carbon atoms in R^{b} may have may include the same examples as those of the substituent that the alkyl group of 1 to 20 carbon atoms in R^{b} may have. The number of substituents may be one or plural. The plurality of substituents may be the same as or different from one another.

Examples of the cycloalkyl group of 3 to 12 carbon atoms in R^{b} may include a cyclopropyl group, a cyclobutyl group, a cyclopentyl group, a cyclohexyl group, and a cyclooctyl group. Among these, as the cycloalkyl group, a cyclopentyl group and a cyclohexyl group are preferable.

Examples of the substituent that the cycloalkyl group of 3 to 12 carbon atoms in R^{b} may have may include a halogen atom such as a fluorine atom and a chlorine atom; a cyano group; an N,N-dialkylamino group of 2 to 12 carbon atoms such as a dimethylamino group; an alkyl group of 1 to 6 carbon atoms such as a methyl group, an ethyl group, and a propyl group; an alkoxy group of 1 to 6 carbon atoms such as a methoxy group, an ethoxy group, and an isopropoxy group; a nitro group; and an aromatic hydrocarbon ring group of 6 to 20 carbon atoms such as a phenyl group and a naphthyl group. Among these, as the substituent of the cycloalkyl group, a halogen atom such as a fluorine atom and a chlorine atom; a cyano group; an alkyl group of 1 to 6 carbon atoms such as a methyl group, an ethyl group, and a propyl group; an alkoxy group of 1 to 6 carbon atoms such as a methoxy group, an ethoxy group, and an isopropoxy group; a nitro group; and an aromatic hydrocarbon ring group of 6 to 20 carbon atoms such as a phenyl group and a naphthyl group are preferable. The number of substituents may be one or plural. The plurality of substituents may be the same as or different from one another.

Examples of the aromatic hydrocarbon ring group of 6 to 12 carbon atoms in R^{b} may include a phenyl group, a 1-naphthyl group, and a 2-naphthyl group. Among these, a phenyl group is preferable as the aromatic hydrocarbon ring group.

Examples of the substituent that the aromatic hydrocarbon ring group of 6 to 12 carbon atoms in R^{b} may have may include a halogen atom such as a fluorine atom and a chlorine atom; a cyano group; an N,N-dialkylamino group of 2 to 12 carbon atoms such as a dimethylamino group; an alkoxy group of 1 to 20 carbon atoms such as a methoxy group, an ethoxy group, an isopropoxy group, and a butoxy group; an alkoxy group of 1 to 12 carbon atoms having an alkoxy group of 1 to 12 carbon atoms as a substituent such as a methoxymethoxy group and a methoxyethoxy group; a nitro group; an aromatic heterocyclic ring group of 2 to 20 carbon atoms such as a triazolyl group, a pyrrolyl group, a furanyl group, and a thiophenyl group; a cycloalkyl group of 3 to 8 carbon atoms such as a cyclopropyl group, a cyclopentyl group, and a cyclohexyl group; a cycloalkyloxy group of 3 to 8 carbon atoms such as a cyclopentyloxy group and a cyclohexyloxy group; a cyclic ether group of 2 to 12 carbon atoms such as a tetrahydrofuranyl group, a tetrahydropyranyl group, a dioxolanyl group, and a dioxanyl group; an aryloxy group of 6 to 14 carbon atoms such as a phenoxy group and a naphthoxy group; a fluoroalkyl group of 1 to 12 carbon atoms in which one or more hydrogen atoms have been substituted with a fluorine atom such as a trifluoromethyl group, a pentafluoroethyl group, and —CH₂CF₃; —OCF₃; a benzofuryl group; a benzopyranyl group; a benzodioxolyl group; and a benzodioxanyl group. Among these, as the substituent of the aromatic hydrocarbon ring group, a halogen atom such as a fluorine atom and a chlorine atom; a cyano group; an alkoxy group of 1 to 20 carbon atoms such as a methoxy group, an ethoxy group, an isopropoxy group, and a butoxy group; a nitro group; an aromatic heterocyclic ring group of 2 to 20 carbon atoms such as a furanyl group and a thiophenyl group; a cycloalkyl group of 3 to 8 carbon atoms such as a cyclopropyl group, a cyclopentyl group, and a cyclohexyl group; a fluoroalkyl group of 1 to 12 carbon atoms in which one or more hydrogen atoms have been substituted with a fluorine atom such as a trifluoromethyl group, a pentafluoroethyl group, and —CH₂CF₃; and —OCF₃ are preferable. The number of substituents may be one or plural. The plurality of substituents may be the same as or different from one another.

The number of carbon atoms of the aromatic heterocyclic ring group in D¹ to D³ is preferably 2 to 30. Examples of the aromatic heterocyclic ring group of 2 to 30 carbon atoms in D¹ to D³ may include a 1-benzofuranyl group, a 2-benzofuranyl group, an imidazolyl group, an indolinyl group, a furazanyl group, an oxazolyl group, a quinolyl group, a thiadiazolyl group, a triazolyl group, a thiazolopyrazinyl group, a thiazolopyridyl group, a thiazolopyridazinyl group, a thiazolopyrimidinyl group, a thienyl group, a triazinyl group, a triazolyl group, a naphthyridinyl group, a pyrazinyl group, a pyrazolyl group, a pyranyl group, a pyridyl group, a pyridazinyl group, a pyrimidinyl group, a pyrrolyl group, a phthalazinyl group, a furanyl group, a benzo[c]thienyl group, a benzo[b]thienyl group, a benzoisoxazolyl group, a benzoisothiazolyl group, a benzimidazolyl group, a benzoxadiazolyl group, a benzoxazolyl group, a benzothiadiazolyl group, a benzothiazolyl group, a benzotriazinyl group, a benzotriazoryl group, and a benzopyrazolyl group. Among these, as the aromatic heterocyclic ring group, a monocyclic aromatic heterocyclic ring group such as a furanyl group, a pyranyl group, a thienyl group, an oxazolyl group, a furazanyl group, a thiazolyl group, and a thiadiazolyl group; and an aromatic heterocyclic ring group having a condensed ring such as a benzothiazolyl group, a benzoxazolyl group, a quinolyl group, a 1-benzofuranyl group, a 2-benzofuranyl group, a phthalimide group, a benzo[c]thienyl group, a benzo[b]thienyl group, a thiazolopyridyl group, a thiazolopyrazinyl group, a benzoisoxazolyl group, a benzoxadiazolyl group, and a benzothiadiazolyl group are more preferable.

Examples of the substituent that the aromatic heterocyclic ring group in D¹ to D³ may have may include the same examples as those of the substituent that the aromatic hydrocarbon ring group in D¹ to D³ may have. The number of substituents may be one or plural. The plurality of substituents may be the same as or different from one another.

In the aforementioned formulae (II-1) to (II-7), each of D⁴ to D⁵ independently represents a non-cyclic group optionally having a substituent. D⁴ and D⁵ may together form a ring. Usually, the numbers of carbon atoms of the respective groups represented by each of D⁴ to D⁵ (including the number of carbon atoms in the substituent) is independently 1 to 100.

The number of carbon atoms of the non-cyclic group in D⁴ to D⁵ is preferably 1 to 13. Examples of the non-cyclic group in D⁴ to D⁵ may include an alkyl group of 1 to 6 carbon atoms; a cyano group; a carboxyl group; a fluoroalkyl group of 1 to 6 carbon atoms; an alkoxy group of 1 to 6 carbon atoms; —C(═O)—CH₃; —C(═O)NHPh; and —C(═O)—OR^{x}. Among these, as the non-cyclic group, a cyano group, a carboxylic group, —C(═O)—CH₃, —C(═O)NHPh, —C(═O)—OC₂H₅, —C(═O)—OC₄H₉, —C(═O)—OCH(CH₃)₂, —C(═O)—OCH₂CH₂CH(CH₃)—OCH₃, —C(═O)—OCH₂CH₂C(CH₃)₂—OH, and —C(═O)—OCH₂CH(CH₂CH₃)—C₄H₉ are preferable. The aforementioned symbol “Ph” represents a phenyl group. The aforementioned symbol R^{x} represents an organic group of 1 to 12 carbon atoms. Specific examples of the R^{x} may include an alkoxy group of 1 to 12 carbon atoms and an alkyl group of 1 to 12 carbon atoms optionally being substituted with a hydroxyl group.

Examples of the substituent that the non-cyclic group in D⁴ to D⁵ may have may include the same examples as those of the substituent that the aromatic hydrocarbon ring group in D¹ to D³ may have. The number of substituents may be one or plural. The plurality of substituents may be the same as or different from one another.

When D⁴ and D⁵ together form a ring, an organic group containing the ring is formed by the aforementioned D⁴ and D⁵. Examples of the organic group may include groups represented by the following formulae. In the following formulae, the symbol “*” represents a position at which each organic group is bonded to the carbon to which D⁴ and D⁵ are bonded.

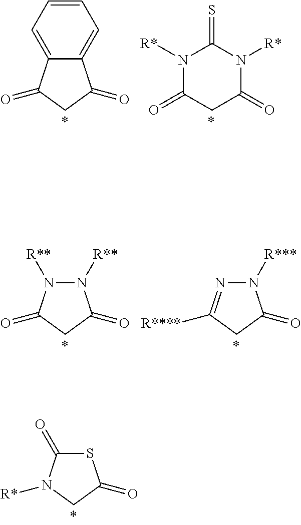

R* represents an alkyl group of 1 to 3 carbon atoms.

R** represents a group selected from the group consisting of an alkyl group of 1 to 3 carbon atoms and a phenyl group optionally having a substituent.

R*** represents a group selected from the group consisting of an alkyl group of 1 to 3 carbon atoms and a phenyl group optionally having a substituent.

R**** represents a group selected from the group consisting of a hydrogen atom, an alkyl group of 1 to 3 carbon atoms, a hydroxyl group, and —COOR¹³. R¹³ represents an alkyl group of 1 to 3 carbon atoms.

Examples of the substituents that the phenyl group may have may include a halogen atom, an alkyl group, an alkenyl group, an aryl group, a heterocyclic ring group, a hydroxyl group, a carboxyl group, an alkoxy group, an aryloxy group, an acyloxy group, a cyano group, and an amino group. Among these, as a substituent, a halogen atom, an alkyl group, a cyano group, and an alkoxy group are preferable. The number of substituents that the phenyl group has may be one or plural. The plurality of substituents may be the same as or different from one another.

In the aforementioned formulae (II-1) to (II-7), D⁶ represents a group selected from the group consisting of —C(R^{f})═N—N(R^{g})R^{h}, —C(R^{f})═N—N═C(R^{g})R^{h}, and —C(R^{f})═N—N═Rⁱ. The number of carbon atoms of the group represented by D⁶ (including the number of carbon atoms in the substituent) is usually 3 to 100.

R^{f} represents a group selected from the group consisting of a hydrogen atom; and an alkyl group of 1 to 6 carbon atoms such as a methyl group, an ethyl group, a propyl group, and an isopropyl group.

R^{g} represents a group selected from the group consisting of a hydrogen atom; and an organic group of 1 to 30 carbon atoms optionally having a substituent.

Examples of the organic group of 1 to 30 carbon atoms optionally having a substituent in R^{g} may include an alkyl group of 1 to 20 carbon atoms optionally having a substituent; a group in which one or more of —CH₂— groups contained in the alkyl group of 1 to 20 carbon atoms are substituted with —O—, —S—, —O—C(═O), —C(═O)—O—, or —C(═O)—(except for cases where two or more —O—'s or two or more —S—'s are adjacently interposed); an alkenyl group of 2 to 20 carbon atoms optionally having a substituent; an alkynyl group of 2 to 20 carbon atoms optionally having a substituent; a cycloalkyl group of 3 to 12 carbon atoms optionally having a substituent; an aromatic hydrocarbon ring group of 6 to 30 carbon atoms optionally having a substituent; an aromatic heterocyclic ring group of 2 to 30 carbon atoms optionally having a substituent; -G^{x}-Y^{x}—F^{x}; SO₂R^{a}; —C(═O)—R^{b}; and —CS—NH—R^{b}. The meanings of R^{a} and R^{b} are as described above.

Preferred ranges of the number of carbon atoms of the alkyl group of 1 to 20 carbon atoms in R^{g} and examples thereof are the same as those of the alkyl group of 1 to 20 carbon atoms in R^{b}.

Examples of the substituent that the alkyl group of 1 to 20 carbon atoms in R^{g} may have may include a halogen atom such as a fluorine atom and a chlorine atom; a cyano group; an N,N-dialkylamino group of 2 to 12 carbon atoms such as a dimethylamino group; an alkoxy group of 1 to 20 carbon atoms such as a methoxy group, an ethoxy group, an isopropoxy group, and a butoxy group; an alkoxy group of 1 to 12 carbon atoms having an alkoxy group of 1 to 12 carbon atoms as a substituent such as a methoxymethoxy group and a methoxyethoxy group; a nitro group; an aromatic hydrocarbon ring group of 6 to 20 carbon atoms such as a phenyl group and a naphthyl group; an aromatic heterocyclic ring group of 2 to 20 carbon atoms such as a triazolyl group, a pyrrolyl group, a furanyl group, and a thiophenyl group; a cycloalkyl group of 3 to 8 carbon atoms such as a cyclopropyl group, a cyclopentyl group, and a cyclohexyl group; a cycloalkyloxy group of 3 to 8 carbon atoms such as a cyclopentyloxy group and a cyclohexyloxy group; a cyclic ether group of 2 to 12 carbon atoms such as a tetrahydrofuranyl group, a tetrahydropyranyl group, a dioxolanyl group, and a dioxanyl group; an aryloxy group of 6 to 14 carbon atoms such as a phenoxy group and a naphthoxy group; a fluoroalkyl group of 1 to 12 carbon atoms in which one or more hydrogen atoms have been substituted with a fluorine atom; a benzofuryl group; a benzopyranyl group; a benzodioxolyl group; a benzodioxanyl group; —SO₂R^{a}; —SR^{b}; an alkoxy group of 1 to 12 carbon atoms substituted with —SR^{b}; and a hydroxyl group. The meanings of R^{a} and R^{b} are as described above. The number of substituents may be one or plural. The plurality of substituents may be the same as or different from one another.

Preferred ranges of the number of carbon atoms of the alkenyl group of 2 to 20 carbon atoms in R^{g} and examples thereof are the same as those of the alkenyl group of 2 to 20 carbon atoms in R^{b}.

Examples of the substituents that the alkenyl group of 2 to 20 carbon atoms in R^{g} may have may include the same examples as those of the substituent that the alkyl group of 1 to 20 carbon atoms in R^{g} may have. The number of substituents may be one or plural. The plurality of substituents may be the same as or different from one another.

Examples of the alkynyl group of 2 to 20 carbon atoms in R^{g} may include an ethynyl group, a propynyl group, a 2-propynyl group (a propargyl group), a butynyl group, a 2-butynyl group, a 3-butynyl group, a pentynyl group, a 2-pentynyl group, a hexynyl group, a 5-hexynyl group, a heptynyl group, an octynyl group, a 2-octynyl group, a nonanyl group, a decanyl group, and a 7-decanyl group.

Examples of the substituent that the alkynyl group of 2 to 20 carbon atoms in R^{g} may have may include the same examples as those of the substituent that the alkyl group of 1 to 20 carbon atoms in R^{g} may have. The number of substituents may be one or plural. The plurality of substituents may be the same as or different from one another.

Examples of the cycloalkyl group of 3 to 12 carbon atoms in R^{g} may include the same example as those of the cycloalkyl group of 3 to 12 carbon atoms in R^{b}.

Examples of the substituent that the cycloalkyl group of 3 to 12 carbon atoms in R^{g} may have may include the same examples as those of the substituent that the alkyl group of 1 to 20 carbon atoms in R^{g} may have. The number of substituents may be one or plural. The plurality of substituents may be the same as or different from one another.

Examples of the aromatic hydrocarbon ring group of 6 to 30 carbon atoms in R^{g} may include the same examples as those of the aromatic hydrocarbon ring group of 6 to 30 carbon atoms in D¹ to D³.

Examples of the substituent that the aromatic hydrocarbon ring group of 6 to 30 carbon atoms in R^{g} may have may include the same examples as those of the substituent that the aromatic hydrocarbon ring group in D¹ to D³ may have. The number of substituents may be one or plural. The plurality of substituents may be the same as or different from one another.

Examples of the aromatic heterocyclic ring group of 2 to 30 carbon atoms in R^{g} may include the same examples as those of the aromatic heterocyclic ring group of 2 to 30 carbon atoms in D¹ to D³.

Examples of the substituent that the aromatic heterocyclic ring group of 2 to 30 carbon atoms in R^{g} may have may include the same examples as those of the substituent that the aromatic hydrocarbon ring group in D¹ to D³. The number of substituents may be one or plural. The plurality of substituents may be the same as or different from one another.

G^{x} represents an organic group selected from the group consisting of a divalent aliphatic hydrocarbon group of 1 to 30 carbon atoms optionally having a substituent; and a group in which one or more of —CH₂— groups contained in a divalent aliphatic hydrocarbon group of 3 to 30 carbon atoms optionally having a substituent are substituted with —O—, —S—, —O—C(═O)—, —C(═O)—O—, —O—C(═O)—O—, —NR¹⁴—C(═O)—, —C(═O)—NR¹⁴—, —NR¹⁴—, or —C(═O)— (except for cases where two or more —O—'s or two or more —S—'s are adjacently interposed). R¹⁴ represents a hydrogen atom or an alkyl group of 1 to 6 carbon atoms. The “divalent aliphatic hydrocarbon group” is preferably a divalent chain aliphatic hydrocarbon group, and more preferably an alkylene group.

Y^{x} represents a group selected from the group consisting of —O—, —C(═O)—, —S—, —C(═O)—O—, —O—C(═O)—, —O—C(═O)—O—, —C(═O)—S—, —S—C(═O)—, —NR¹⁵—C(═O)—, —C(═O)—NR¹⁵—, —O—C(═O)—NR¹⁵—, —NR¹⁵—C(═O)—O—, —N═N—, and —C≡C—. R¹⁵ represents a hydrogen atom or an alkyl group of 1 to 6 carbon atoms. Among these, as Y^{x}, —O—, —O—C(═O)—O—, and —C(═O)—O— are preferable.

F^{x} represents an organic group of at least one of an aromatic hydrocarbon ring and an aromatic heterocyclic ring. The number of carbon atoms of the organic group is preferably 2 or more, more preferably 7 or more, still more preferably 8 or more, and particularly preferably 10 or more, and is preferably 30 or less. The number of carbon atoms of the aforementioned organic group does not include carbon atoms of the substituent.

Examples of the aromatic hydrocarbon ring in F^{x} may include an aromatic hydrocarbon ring of 6 to 30 carbon atoms such as a benzene ring, a naphthalene ring, an anthracene ring, a phenanthrene ring, a pyrene ring, and a fluorene ring. When F^{x} has a plurality of aromatic hydrocarbon rings, the plurality of aromatic hydrocarbon rings may be the same as or different from one another.

The aromatic hydrocarbon ring in F^{x} may have a substituent. Examples of the substituent that the aromatic hydrocarbon ring in F^{x} may have may include a halogen atom such as a fluorine atom and a chlorine atom; a cyano group; an alkyl group of 1 to 6 carbon atoms such as a methyl group, an ethyl group, and a propyl group; an alkenyl group of 2 to 6 carbon atoms such as a vinyl group and an allyl group; an alkyl halide group of 1 to 6 carbon atoms such as a trifluoromethyl group and a pentafluoroethyl group; an N,N-dialkylamino group of 2 to 12 carbon atoms such as a dimethylamino group; an alkoxy group of 1 to 6 carbon atoms such as a methoxy group, an ethoxy group, and an isopropoxy group; a nitro group; —OCF₃; —C(═O)—R^{b}; —C(═O)—O—R^{b}; and —O—C(═O)—R^{b}. The meaning of R^{b} is as described above. The number of substituents may be one or plural. The plurality of substituents may be the same as or different from one another.

Examples of the aromatic heterocyclic ring in F^{x} may include an aromatic heterocyclic ring of 2 to 30 carbon atoms such as a 1H-isoindole-1,3(2H)-dione ring, a 1-benzofuran ring, a 2-benzofuran ring, an acridine ring, an isoquinoline ring, an imidazole ring, an indole ring, an oxadiazole ring, an oxazole ring, an oxazolopyrazine ring, an oxazolopyridine ring, an oxazolopyridazyl ring, an oxazolopyrimidine ring, a quinazoline ring, a quinoxaline ring, a quinoline ring, a cinnoline ring, a thiadiazole ring, a triazole ring, a thiazolopyrazine ring, a thiazolopyridine ring, a thiazolopyridazine ring, a thiazolopyrimidine ring, a thiophene ring, a triazine ring, a triazole ring, a naphthyridine ring, a pyrazine ring, a pyrazole ring, a pyranone ring, a pyran ring, a pyridine ring, a pyridazine ring, a pyrimidine ring, a pyrrole ring, a phenanthridine ring, a phthalazine ring, a furan ring, a benzo[c]thiophen ring, a benzoisoxazole ring, a benzoisothiazole ring, a benzimidazole ring, a benzoxadiazole ring, a benzoxazole ring, a benzothiadiazole ring, a benzothiazole ring, a benzothiophene ring, a benzotriazine ring, a benzotriazole ring, a benzopyrazole ring, and a benzopyranone ring. When F^{x} has a plurality of aromatic heterocyclic rings, the plurality of aromatic heterocyclic rings may be the same as or different from one another.

The aromatic heterocyclic ring in F^{x} may have a substituent. Examples of the substituent that the aromatic heterocyclic ring in F^{x} may have may include the same examples as those of the substituent that the aromatic hydrocarbon ring in F^{x} may have. The number of substituents may be one or plural. The plurality of substituents may be the same as or different from one another.

Preferable examples of F^{x} may include a “cyclic group of 2 to 20 carbon atoms having at least one of an aromatic hydrocarbon ring and an aromatic heterocyclic ring, and optionally having a substituent”. This cyclic group may hereinafter be referred to as a “cyclic group (a)” as appropriate.

Examples of the substituent that the cyclic group (a) may have may include the same substituents as those of the substituent that the aromatic hydrocarbon ring in F^{x} may have. The number of substituents may be one or plural. The plurality of substituents may be the same as or different from one another.

Preferable examples of the cyclic group (a) may include a hydrocarbon ring group of 6 to 20 carbon atoms having at least one aromatic hydrocarbon ring of 6 to 18 carbon atoms and optionally having a substituent. This hydrocarbon ring group may hereinafter be referred to as a “hydrocarbon ring group (a1)” as appropriate.

Examples of the hydrocarbon ring group (a1) may include an aromatic hydrocarbon ring group of 6 to 18 carbon atoms such as a phenyl group (6 carbon atoms), a naphthyl group (10 carbon atoms), an anthracenyl group (14 carbon atoms), a phenanthrenyl group (14 carbon atoms), a pyrenyl group (16 carbon atoms), a fluorenyl group (13 carbon atoms), an indanyl group (9 carbon atoms), a 1,2,3,4-tetrahydronaphthyl group (10 carbon atoms), and a 1,4-dihydronaphthyl group (10 carbon atoms).

Specific examples of the aforementioned hydrocarbon ring group (a1) may include groups represented by the following formulae (1-1) to (1-21). These groups may have a substituent. In the formulae below, the symbol “—” represents a bond with Y^{x} extending from any optional position in the ring.

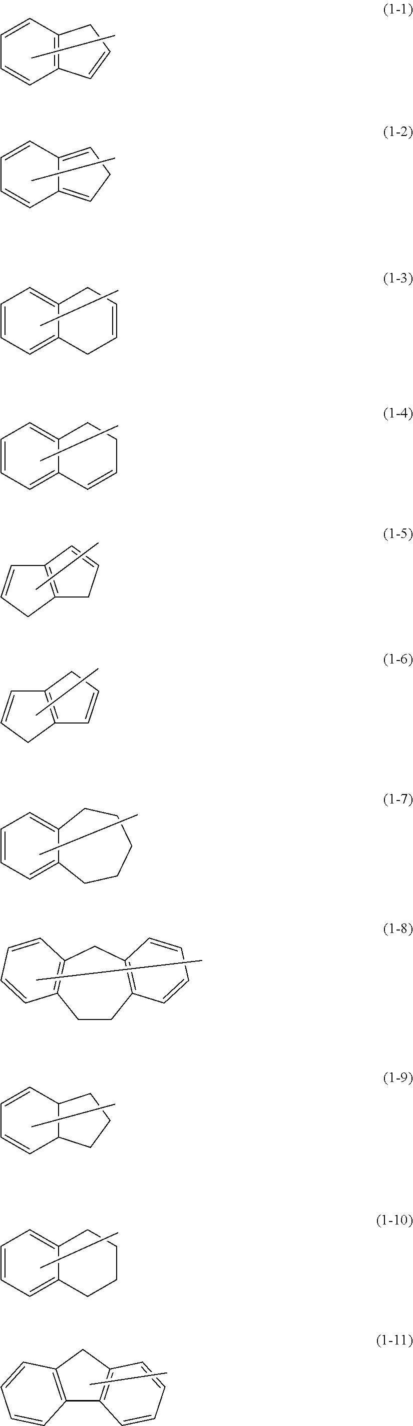

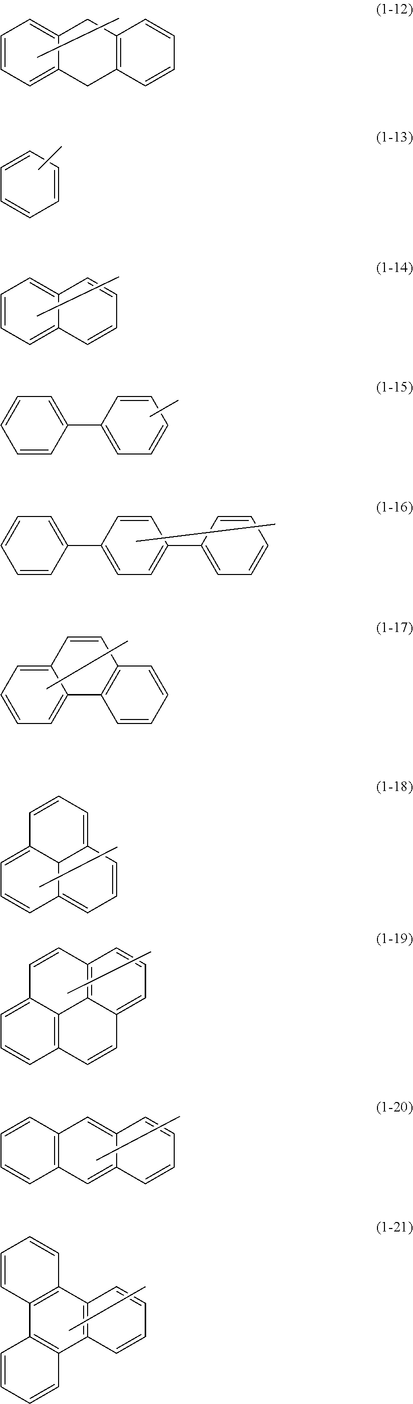

Other preferable examples of the cyclic group (a) may include a heterocyclic ring group of 2 to 20 carbon atoms having one or more aromatic rings selected from the group consisting of an aromatic hydrocarbon ring of 6 to 18 carbon atoms and an aromatic heterocyclic ring of 2 to 18 carbon atoms, and optionally having a substituent. This heterocyclic ring group may hereinafter be referred to as a “heterocyclic ring group (a2)” as appropriate.

Examples of the heterocyclic ring group (a2) may include an aromatic heterocyclic ring group of 2 to 18 carbon atoms such as a phthalimide group, a 1-benzofuranyl group, a 2-benzofuranyl group, an acridinyl group, an isoquinolinyl group, an imidazolyl group, an indolinyl group, a furazanyl group, an oxazolyl group, an oxazolopyrazinyl group, an oxazolopyridinyl group, an oxazolopyridazinyl group, an oxazolopyrimidinyl group, a quinazolinyl group, a quinoxalinyl group, a quinolyl group, a cinnolinyl group, a thiadiazolyl group, a triazolyl group, a thiazolopyrazinyl group, a thiazolopyridinyl group, a thiazolopyridazinyl group, a thiazolopyrimidinyl group, a thienyl group, a triazinyl group, a triazolyl group, a naphthyridinyl group, a pyrazinyl group, a pyrazolyl group, a pyranonyl group, a pyranyl group, a pyridyl group, a pyridazinyl group, a pyrimidinyl group, a pyrrolyl group, a phenanthridinyl group, a phthalazinyl group, a furanyl group , a benzo[c]thienyl group, a benzoisoxazolyl group, a benzoisothiazolyl group, a benzimidazolyl group, a benzoxazolyl group, a benzothiadiazolyl group, a benzothiazolyl group, a benzothiophenyl group, a benzotriazinyl group, a benzotriazolyl group, a benzopyrazolyl group, and a benzopyranonyl group; a xanthenyl group; a 2,3-dihydroindolyl group; a 9,10-dihydroacridinyl group; a 1,2,3,4-tetrahydroquinolyl group; a dihydropyranyl group; a tetrahydropyranyl group; a dihydrofuranyl group; and a tetrahydrofuranyl group.

Specific examples of the aforementioned heterocyclic ring group (a2) may include groups represented by the following formulae (2-1) to (2-51). These groups may have a substituent. In the formulae below, the symbol “—” represents a bond with Y^{x} extending from any optional position in the ring. In the formulae below, X represents —CH₂—, —NR^{c}—, an oxygen atom, a sulfur atom, —SO—, or —SO₂—. Each of Y and Z independently represents —NR^{c}—, an oxygen atom, a sulfur atom, —SO—, or —SO₂—. E represents —NR^{c}—, an oxygen atom, or a sulfur atom. Herein, R^{c} represents a hydrogen atom; or an alkyl group of 1 to 6 carbon atoms such as a methyl group, an ethyl group, and a propyl group. (However, in each of the formulae, cases wherein the oxygen atoms, the sulfur atoms, —SO—'s, or —SO₂—'s are adjacently exist are excluded.

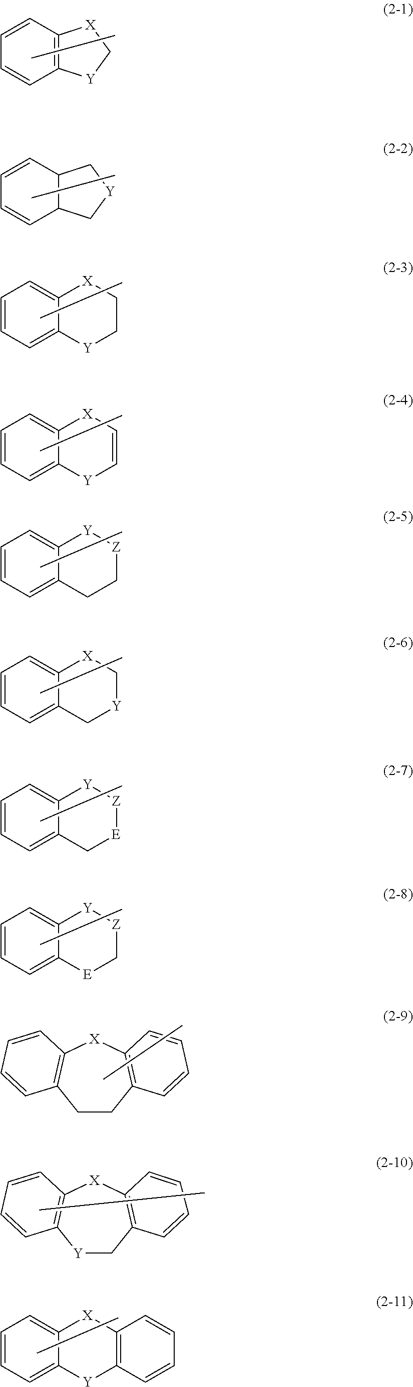

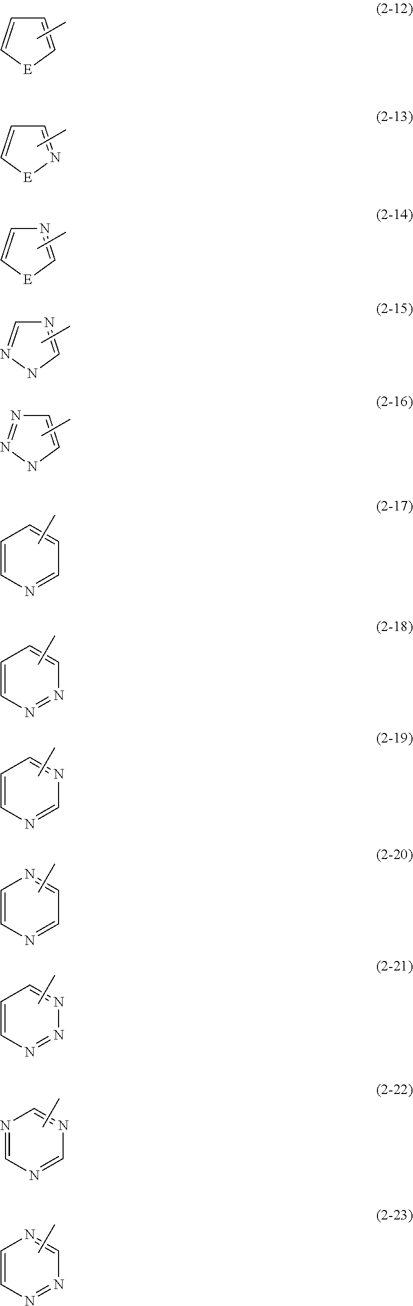

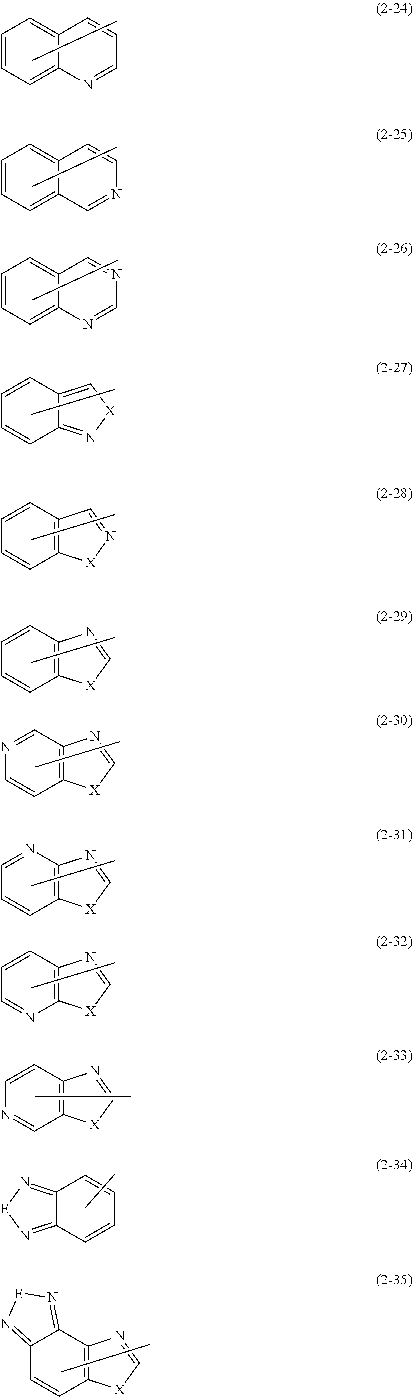

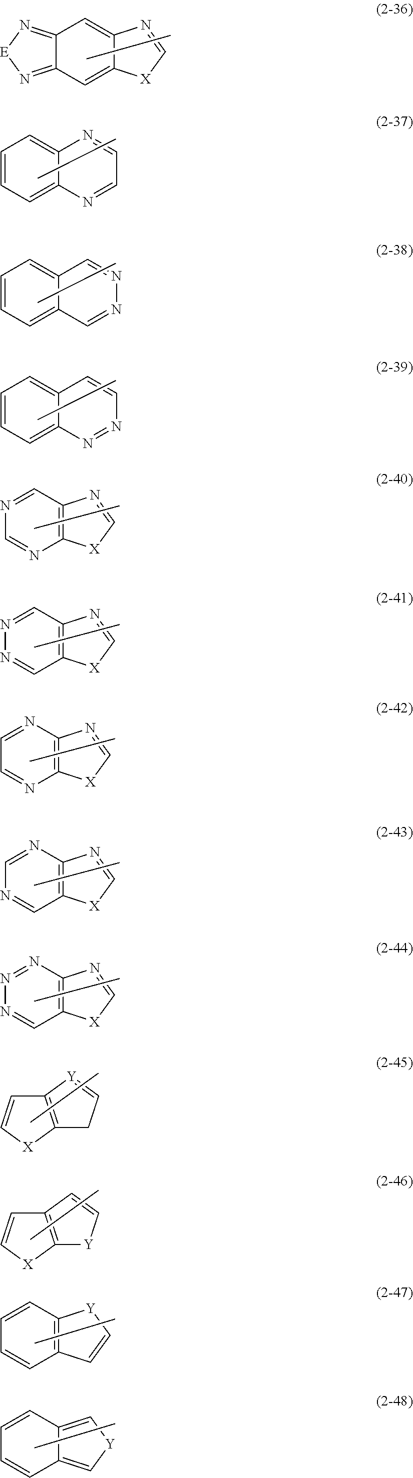

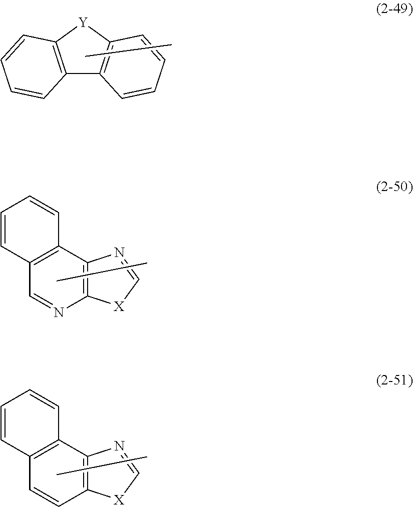

Other preferable examples of F^{x} may include an “alkyl group of 1 to 18 carbon atoms in which at least one hydrogen atom is substituted with a cyclic group of 2 to 20 carbon atoms having at least one of an aromatic hydrocarbon ring and an aromatic heterocyclic ring and optionally having a substituent, and which optionally has a substituent other than the cyclic group”. The substituted alkyl group may hereinafter be referred to as a “substituted alkyl group (b)” as appropriate.

Examples of the alkyl group of 1 to 18 carbon atoms in the substituted alkyl group (b) may include a methyl group, an ethyl group, a propyl group, and an isopropyl group.

Examples of the “cyclic group of 2 to 20 carbon atoms having at least one of an aromatic hydrocarbon ring and an aromatic heterocyclic ring and optionally having a substituent” in the substituted alkyl group (b) may include the groups in the range described as the cyclic group (a).

In the substituted alkyl group (b), “at least one of an aromatic hydrocarbon ring and an aromatic heterocyclic ring” may be directly bonded to a carbon atom of the alkyl group of 1 to 18 carbon atoms or may be bonded thereto via a linking group. Examples of the linking group may include —S—, —O—, —C(═O)—, —C(═O)—O—, —O—C(═O)—, —O—C(═O)—O—, —C(═O)—S—, —S—C(═O)—, —NR¹⁵—C(═O)—, and —C(═O)—NR¹⁵. The meaning of R¹⁵ is as described above. Thus, examples of the “cyclic group of 2 to 20 carbon atoms having at least one of an aromatic hydrocarbon ring and an aromatic heterocyclic ring and optionally having a substituent” in the substituted alkyl group (b) may include a group having at least one of an aromatic hydrocarbon ring and an aromatic heterocyclic ring such as a fluorenyl group and a benzothiazolyl group; an optionally substituted aromatic hydrocarbon ring group; an optionally substituted aromatic heterocyclic ring group; a group composed of an optionally substituted aromatic hydrocarbon ring having a linking group; and a group composed of an optionally substituted aromatic heterocyclic ring having a linking group.

Preferable examples of the aromatic hydrocarbon ring group in the substituted alkyl group (b) may include an aromatic hydrocarbon ring group of 6 to 20 carbon atoms such as a phenyl group, a naphthyl group, an anthracenyl group, a phenanthrenyl group, a pyrenyl group, and a fluorenyl group.

The aromatic hydrocarbon ring group in the substituted alkyl group (b) may have a substituent. Examples of the substituent may include the same examples as those of the substituent that the aromatic hydrocarbon ring in F^{x} may have. The number of substituents may be one or plural. The plurality of substituents may be the same as or different from one another.

Preferable examples of the aromatic heterocyclic ring group in the substituted alkyl group (b) may include an aromatic heterocyclic ring group of 2 to 20 carbon atoms such as a phthalimide group, a 1-benzofuranyl group, a 2-benzofuranyl group, an acridinyl group, an isoquinolinyl group, an imidazolyl group, an indolinyl group, a furazanyl group, an oxazolyl group, an oxazolopyrazinyl group, an oxazolopyridinyl group, an oxazolopyridazinyl group, an oxazolopyrimidinyl group, a quinazolinyl group, a quinoxalinyl group, a quinolyl group, a cinnolinyl group, a thiadiazolyl group, a triazolyl group, a thiazolopyrazinyl group, a thiazolopyridyl group, a thiazolopyridazinyl group, a thiazolopyrimidinyl group , a thienyl group, a triazinyl group, a triazolyl group, a naphthyridinyl group, a pyrazinyl group, a pyrazolyl group, a pyranonyl group, a pyranyl group, a pyridyl group, a pyridazinyl group, a pyrimidinyl group, a pyrrolyl group, a phenanthridinyl group, a phthalazinyl group, a furanyl group, a benzo[c]thienyl group, a benzoisoxazolyl group, a benzoisothiazolyl group, a benzimidazolyl group, a benzoxadiazolyl group, a benzoxazolyl group, a benzothiadiazolyl group, a benzothiazolyl group, a benzothienyl group, a benzotriazinyl group, a benzotriazolyl group, a benzopyrazolyl group, and a benzopyranonyl group.

The aromatic heterocyclic ring group in the substituted alkyl group (b) may have a substituent. Examples of the substituent may include the same examples as those of the substituent that the aromatic hydrocarbon ring in F^{x} may have. The number of substituents may be one or plural. The plurality of substituents may be the same as or different from one another.

Examples of the “group composed of an aromatic hydrocarbon ring having a linking group” and the “group composed of an aromatic heterocyclic ring having a linking group” in the substituted alkyl group (b) may include a phenylthio group, a naphthylthio group, an anthracenylthio group, a phenanthrenylthio group, a pyrenylthio group, a fluorenylthio group, a phenyloxy group, a naphthyloxy group, an anthracenyloxy group, a phenanthrenyloxy group, a pyrenyloxy group, a fluorenyloxy group, a benzoisoxazolylthio group, a benzoisothiazolylthio group, a benzoxadiazolylthio group, a benzoxazolylthio group, a benzothiadiazolylthio group, a benzothiazolylthio group, a benzothienylthio group, a benzoisoxazolyloxy group, a benzoisothiazolyloxy group, a benzoxadiazolyloxy group, a benzoxazolyloxy group, a benzothiadiazolyloxy group, a benzothiazolyloxy group, a benzothienyloxy group.

The “group composed of an aromatic hydrocarbon ring having a linking group” and the “group composed of an aromatic heterocyclic ring having a linking group” in the substituted alkyl group (b) may each have a substituent. Examples of the substituent may include the same examples as those of the substituent that the aromatic hydrocarbon ring in F^{x} may have. The number of substituents may be one or plural. The plurality of substituents may be the same as or different from one another.

Examples of the substituent other than the cyclic group that the substituted alkyl group (b) may have may include the same examples as those of the substituent that the aromatic hydrocarbon ring in F^{x} may have. The number of substituents may be one or plural. The plurality of substituents may be the same as or different from one another.

Specific examples of the substituted alkyl group (b) may include groups represented by the following formulae (3-1) to (3-11). These groups may have a substituent. In the formulae below, the symbol “—” represents a bond with Y^{x} extending from any optional position in the ring. In the following formulae, the symbol “*” represents a position for bonding.

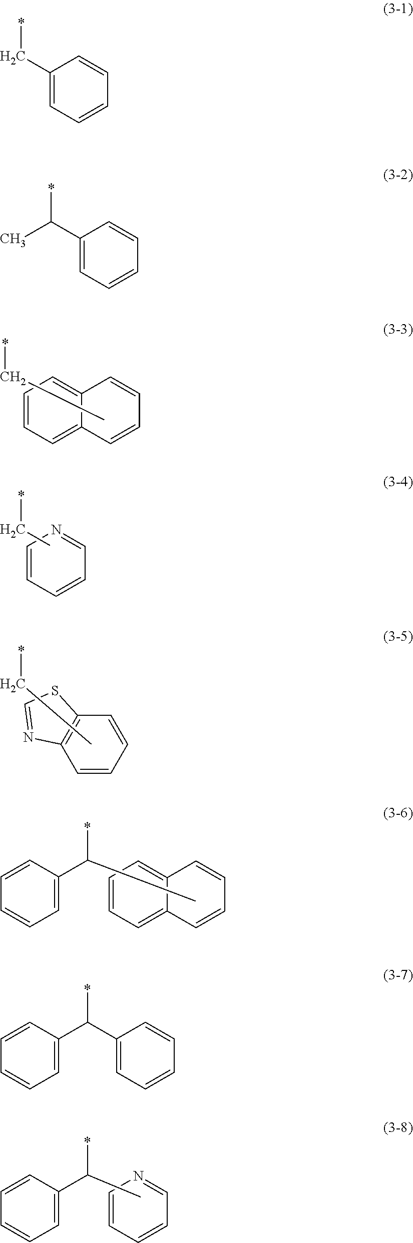

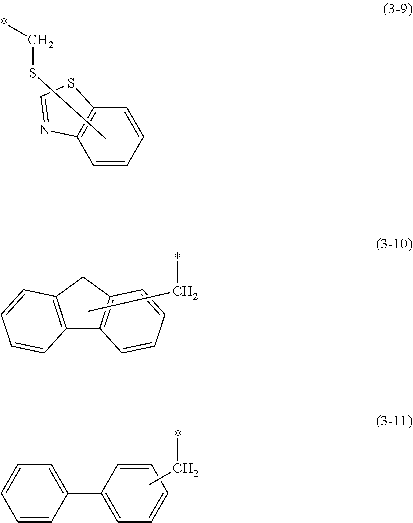

In particular, when Ar is represented by the formula (II-5), F^{x} is preferably a group represented by any of the following formulae (i-1) to (i-9). In particular, when Ar is represented by the formula (II-6) or formula (II-7), F^{x} is preferably a group represented by any of the following formulae (i-1) to (i-13). The groups represented by the following formulae (i-1) to (i-13) may have a substituent. In the following formula, the symbol “*” represents a position for bonding.

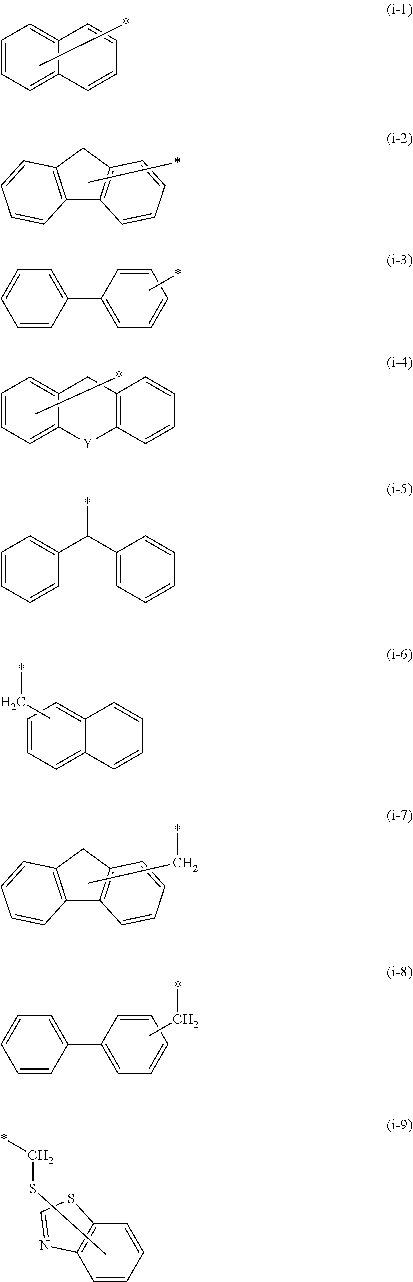

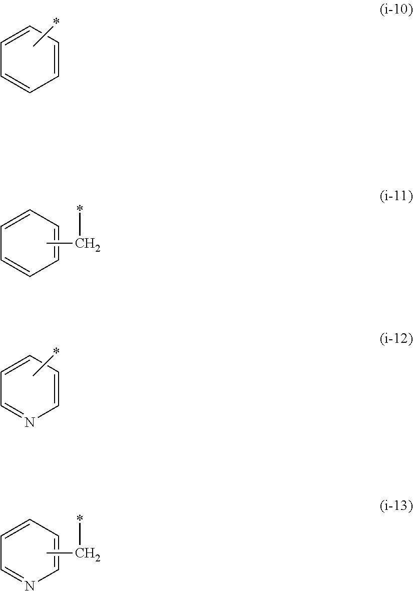

Further, when Ar is represented by the formula (II-5), F^{x} is particularly preferably a group represented by any of the following formulae (ii-1) to (ii-18) below.

When Ar is represented by the formula (II-6) or formula (II-7), F^{x} is particularly preferably a group represented by any of the following formulae (ii-1) to (ii-24). The groups represented by the following formulae (ii-1) to (ii-24) may have a substituent. In the following formulae, the meaning of Y is as described above. In the following formulae, the symbol “*” represents a position for bonding.

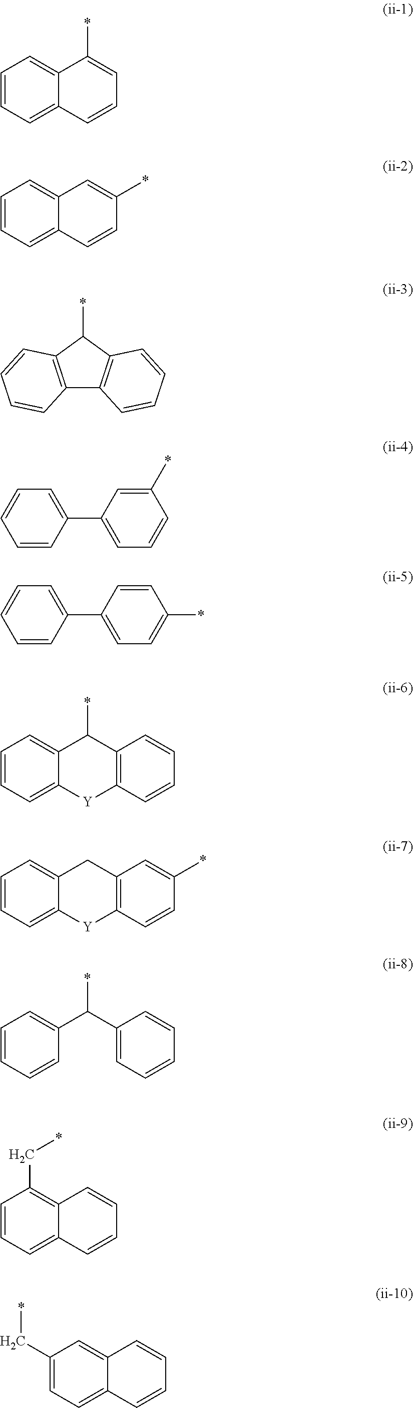

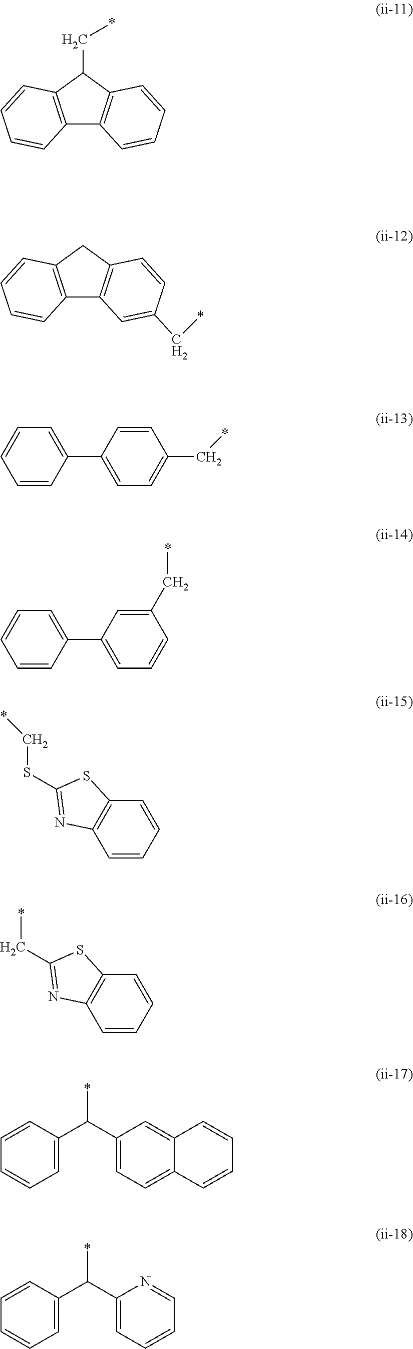

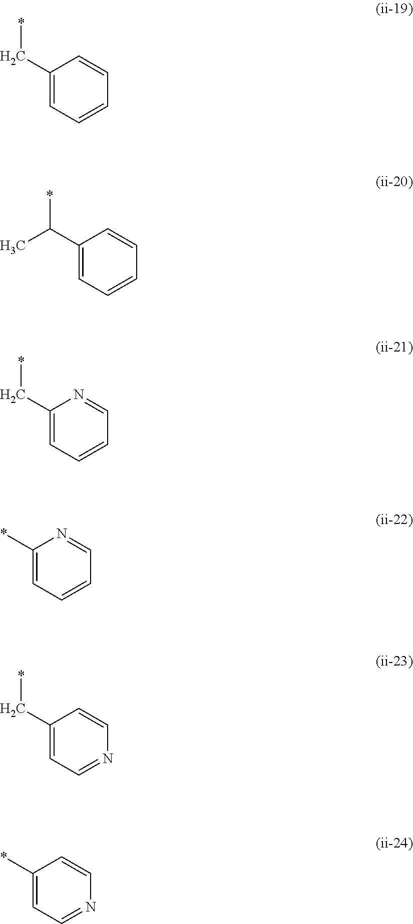

When Ar is represented by the formula (II-5), the total number of 7c electrons contained in the ring structures in F^{x} is preferably 8 or more, and more preferably 10 or more, and is preferably 20 or less, and more preferably 18 or less. When Ar is represented by the formula (II-6) or formula (II-7), the total number of π electrons contained in the ring structures in F^{x} is preferably 4 or more, and more preferably 6 or more, and is preferably 20 or less, and more preferably 18 or less.

Among the groups described above, as R^{g}, an alkyl group of 1 to 20 carbon atoms optionally having a substituent; a group in which one or more of —CH₂— groups contained in the alkyl group of 1 to 20 carbon atoms are substituted with —O—, —S—, —O—C(═O), —C(═O)—O—, or —C(═O)—(except for cases where two or more —O—'s or two or more —S—'s are adjacently interposed); a cycloalkyl group of 3 to 12 carbon atoms optionally having a substituent; an aromatic hydrocarbon ring group of 6 to 30 carbon atoms optionally having a substituent; an aromatic heterocyclic ring group of 2 to 30 carbon atoms optionally having a substituent; and -G^{x}-Y^{x}—F^{x} are preferable. Among these, as R^{g}, an alkyl group of 1 to 20 carbon atoms optionally having a substituent; a group in which one or more of —CH₂— groups contained in the alkyl group of 1 to 20 carbon atoms are substituted with —O—, —S—, —O—C(═O), —C(═O)—O—, or —C(═O)— (except for cases where two or more —O—'s or two or more —S—'s are adjacently interposed); an aromatic hydrocarbon ring group of 6 to 30 carbon atoms optionally having a substituent; and -G^{x}-Y^{x}—F^{x} are particularly preferable.

R^{h} represents an organic group having one or more aromatic rings selected from the group consisting of an aromatic hydrocarbon ring of 6 to 30 carbon atoms and an aromatic heterocyclic ring of 2 to 30 carbon atoms.

Preferable examples of R^{h} may include a (1) hydrocarbon ring group of 6 to 40 carbon atoms having one or more aromatic hydrocarbon rings each having 6 to 30 carbon atoms. The hydrocarbon ring group having an aromatic hydrocarbon ring may hereinafter be referred to as “(1) hydrocarbon ring group” as appropriate. Specific examples of the (1) hydrocarbon ring group may include the following groups:

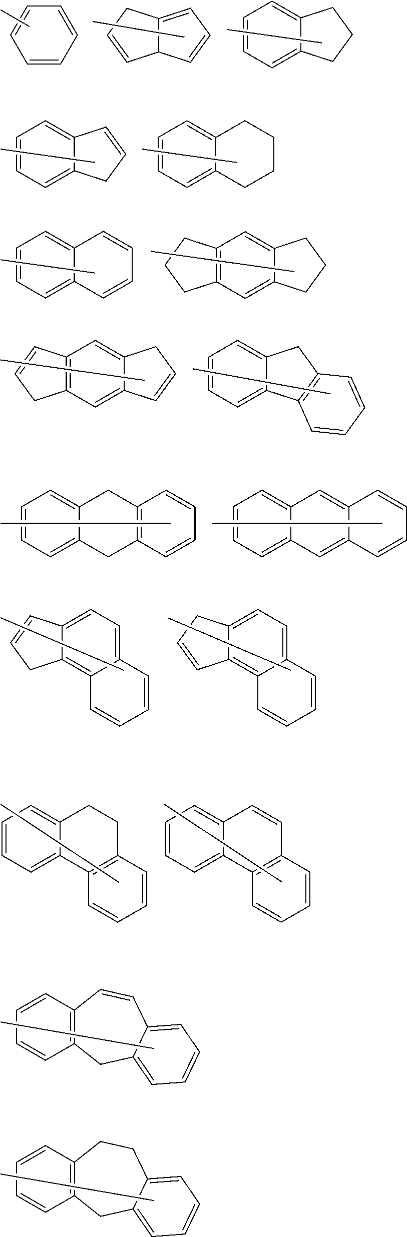

The (1) hydrocarbon ring group may have a substituent. Examples of the substituent that the (1) hydrocarbon ring group may have may include a halogen atom such as a fluorine atom and a chlorine atom; a cyano group; an alkyl group of 1 to 6 carbon atoms such as a methyl group, an ethyl group, and a propyl group; an alkenyl group of 2 to 6 carbon atoms such as a vinyl group and an allyl group; an alkyl halide group of 1 to 6 carbon atoms such as a trifluoromethyl group; an N,N-dialkylamino group of 2 to 12 carbon atoms such as a dimethylamino group; an alkoxy group of 1 to 6 carbon atoms such as a methoxy group, an ethoxy group, and an isopropoxy group; a nitro group; an aromatic hydrocarbon ring group such as a phenyl group and a naphthyl group; —OCF₃; —C(═O)—R^{b}; —O—C(═O)—R^{b}; —C(═O)—O—R^{b}; and —SO₂R^{a}. The meanings of R^{a} and R^{b} are as described above. Among these, a halogen atom, a cyano group, an alkyl group of 1 to 6 carbon atoms, and an alkoxy group of 1 to 6 carbon atoms are preferable. The number of substituents may be one or plural. The plurality of substituents may be the same as or different from one another.

Other preferable examples of R^{h} may include a (2) heterocyclic ring group of 2 to 40 carbon atoms having one or more aromatic rings selected from the group consisting of an aromatic hydrocarbon ring of 6 to 30 carbon atoms and an aromatic heterocyclic ring of 2 to 30 carbon atoms. This heterocyclic ring group having an aromatic ring is hereinafter referred to as “(2) heterocyclic ring group” as appropriate. Specific examples of the (2) heterocyclic ring group may include the following groups. Each of R's independently represents a hydrogen atom or an alkyl group of 1 to 6 carbon atoms.

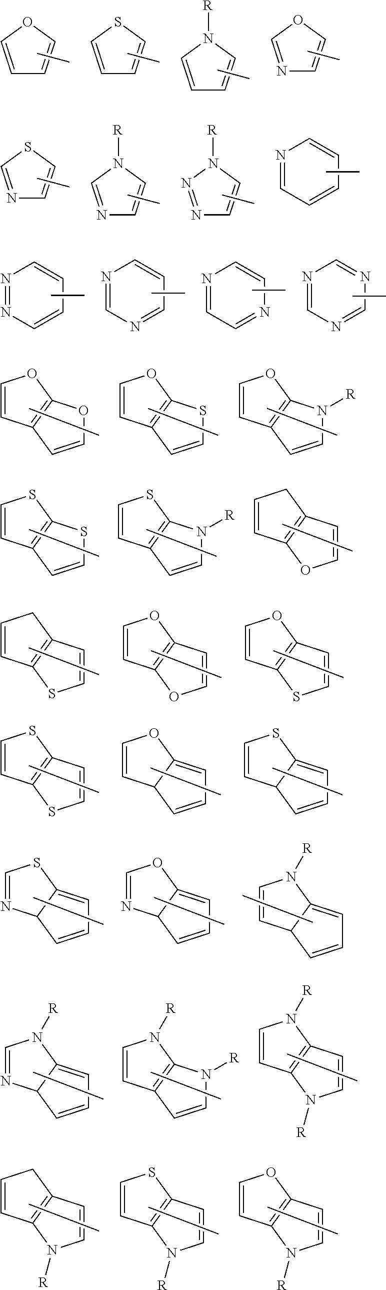

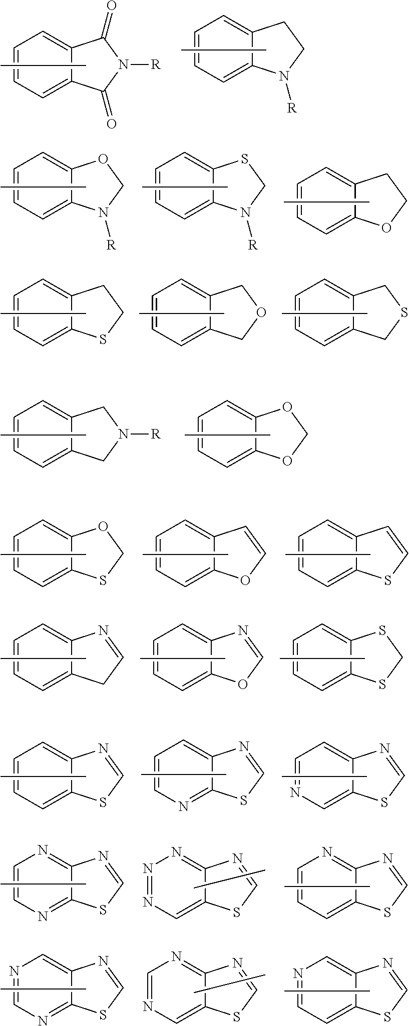

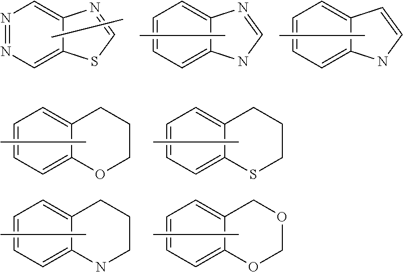

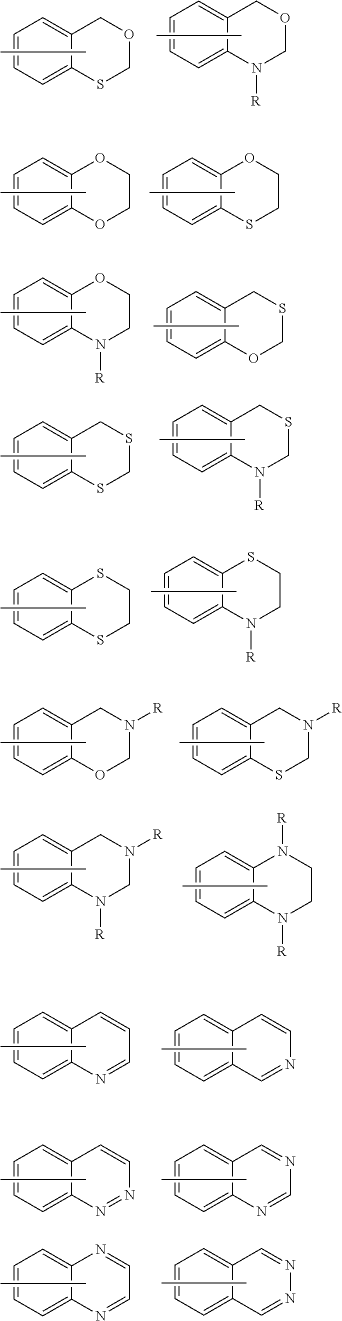

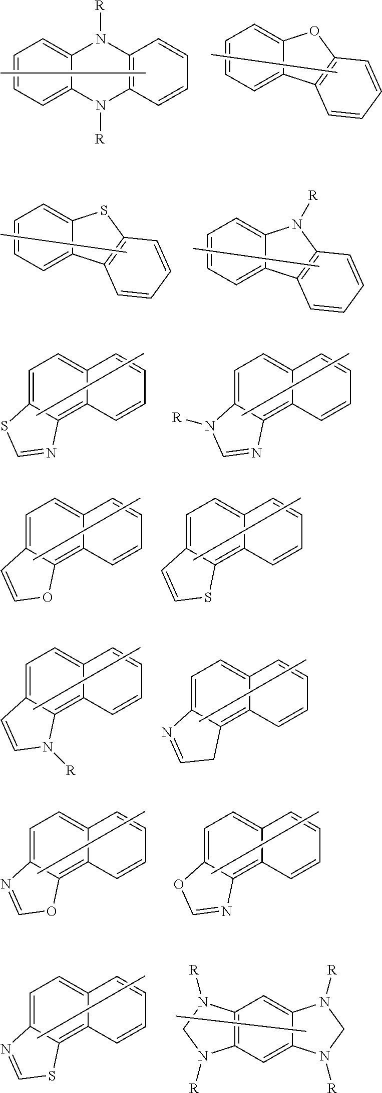

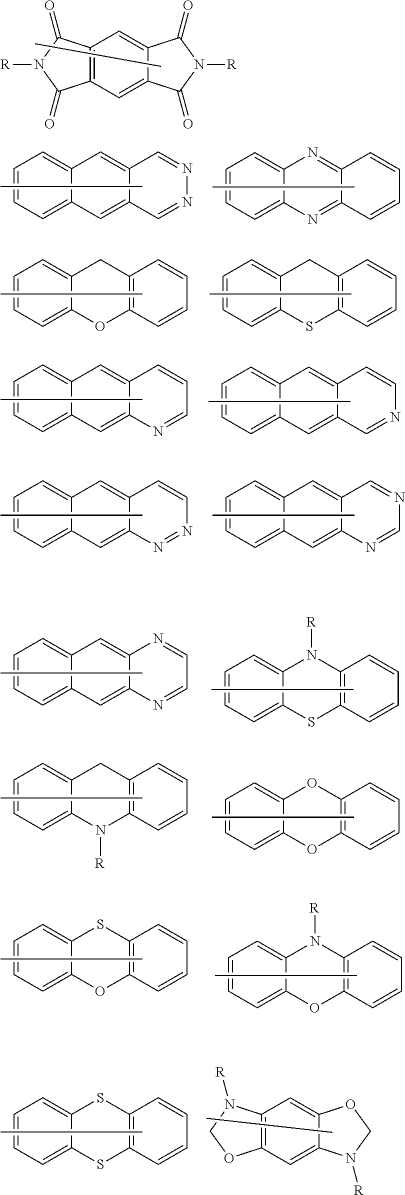

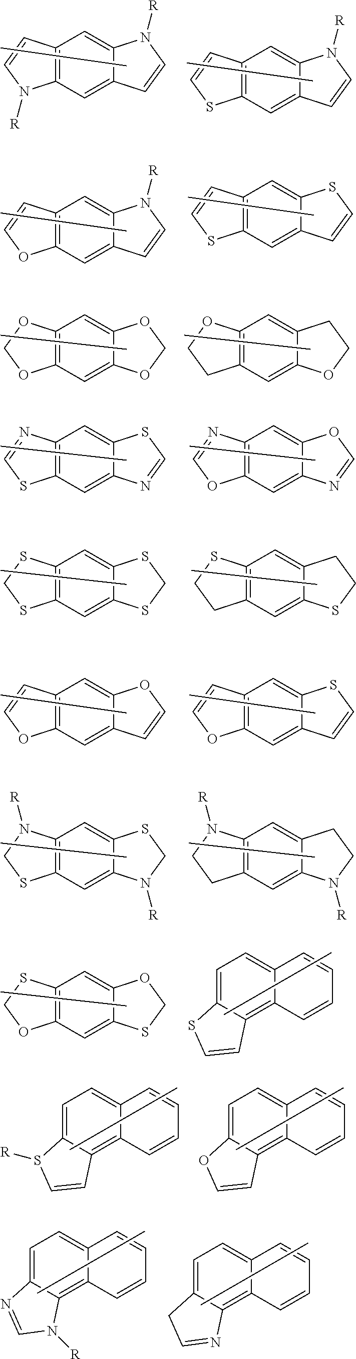

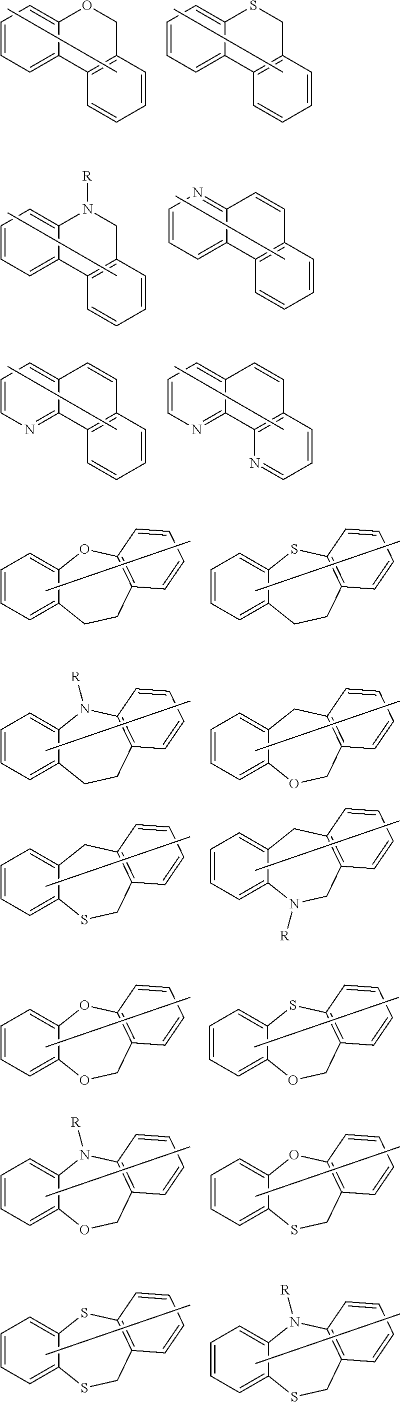

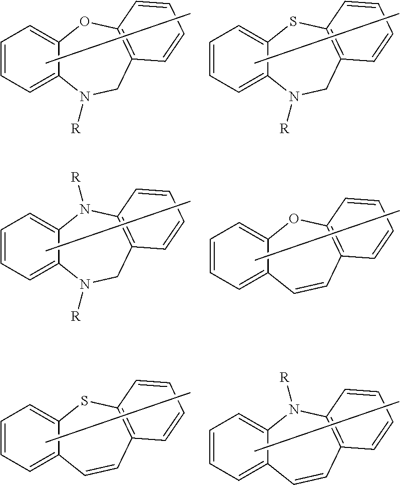

The (2) heterocyclic ring group may have a substituent. Examples of the substituents that the (2) heterocyclic ring group may have may include the same examples as those of the substituent that the (1) hydrocarbon ring group may have. The number of substituents may be one or plural. The plurality of substituents may be the same as or different from one another.

Still other preferable examples of R^{h} may include an (3) alkyl group of 1 to 12 carbon atoms substituted with one or more groups selected from the group consisting of an aromatic hydrocarbon ring group of 6 to 30 carbon atoms and an aromatic heterocyclic ring group of 2 to 30 carbon atoms. This substituted alkyl group may hereinafter be referred to as “(3) substituted alkyl group” as appropriate.

Examples of the “alkyl group of 1 to 12 carbon atoms” in the (3) substituted alkyl group may include a methyl group, an ethyl group, a propyl group, and an isopropyl group.

Examples of the “aromatic hydrocarbon ring group of 6 to 30 carbon atoms” in the (3) substituted alkyl group may include the same examples as those of the aromatic hydrocarbon ring group of 6 to 30 carbon atoms in D¹ to D³. Examples of the “aromatic heterocyclic ring group of 2 to 30 carbon atoms” in the (3) substituted alkyl group may include the same examples as those of the aromatic heterocyclic ring group of 2 to 30 carbon atoms in D¹ to D³.

The (3) substituted alkyl group may further have a substituent. Examples of the substituent that the (3) substituted alkyl group may have may include the same examples as those of the substituent that the (1) hydrocarbon ring group may have. The number of substituents may be one or plural. The plurality of substituents may be the same as or different from one another.

Still other preferable examples of R^{h} may include an (4) alkenyl group of 2 to 12 carbon atoms substituted with one or more groups selected from the group consisting of an aromatic hydrocarbon ring group of 6 to 30 carbon atoms and an aromatic heterocyclic ring group of 2 to 30 carbon atoms. This substituted alkenyl group may hereinafter be referred to as “(4) substituted alkenyl group” as appropriate.

Examples of the “alkenyl group of 2 to 12 carbon atoms” in the (4) substituted alkenyl group may include a vinyl group and an allyl group.

Examples of the “aromatic hydrocarbon ring group of 6 to 30 carbon atoms” in the (4) substituted alkenyl group may include the same examples as those of the aromatic hydrocarbon ring group of 6 to 30 carbon atoms in D¹ to D³.

Examples of the “aromatic heterocyclic ring group of 2 to 30 carbon atoms” in the (4) substituted alkenyl group may include the same examples as those of the aromatic heterocyclic ring group of 2 to 30 carbon atoms in D¹ to D³.

The (4) substituted alkenyl group may further have a substituent. Examples of the substituent that the (4) substituted alkenyl group may have may include the same examples as those of the substituent that the (1) hydrocarbon ring group may have. The number of substituents may be one or plural. The plurality of substituents may be the same as or different from one another.

Still other preferable examples of R^{h} may include an (5) alkynyl group of 2 to 12 carbon atoms substituted with one or more groups selected from the group consisting of an aromatic hydrocarbon ring group of 6 to 30 carbon atoms and an aromatic heterocyclic ring group of 2 to 30 carbon atoms. This substituted alkynyl group may hereinafter be referred to as “(5) substituted alkynyl group” as appropriate.

Examples of the “ alkynyl group of 2 to 12 carbon atoms” in the (5) substituted alkynyl group may include an ethynyl group and a propynyl group.

Examples of the “aromatic hydrocarbon ring group of 6 to 30 carbon atoms” in the (5) substituted alkynyl group may include the same examples as those of the aromatic hydrocarbon ring group of 6 to 30 carbon atoms in D¹ to D³.

Examples of the “aromatic heterocyclic ring group of 2 to 30 carbon atoms” in the (5) substituted alkynyl group may include the same examples as those of the aromatic heterocyclic ring group of 2 to 30 carbon atoms in D¹ to D³.

The (5) substituted alkynyl group may further have a substituent. Examples of the substituent that the (5) substituted alkynyl group may have may include the same examples as those of the substituent that the (1) hydrocarbon ring group may have. The number of substituents may be one or plural. The plurality of substituents may be the same as or different from one another.

Preferable specific examples of R^{h} may include the following groups.

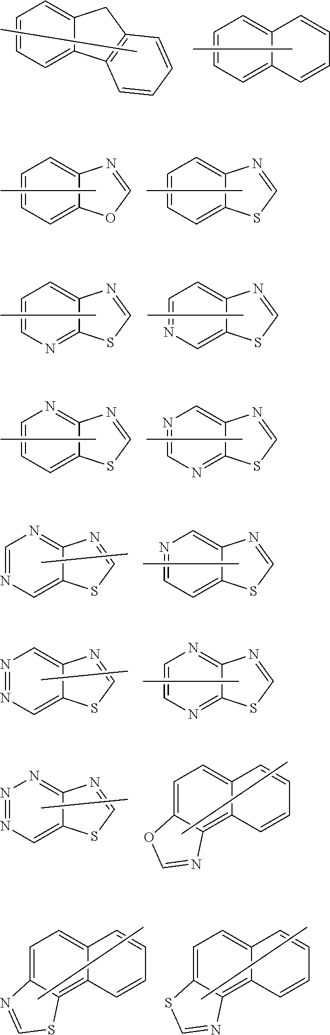

Further preferable specific examples of R^{h} may include the following groups.

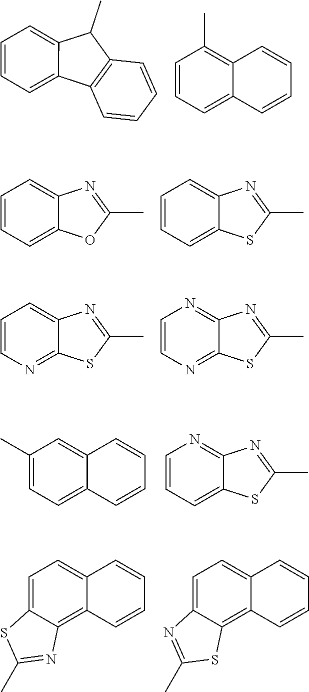

Particularly preferable specific examples of R^{h} may include the following groups.

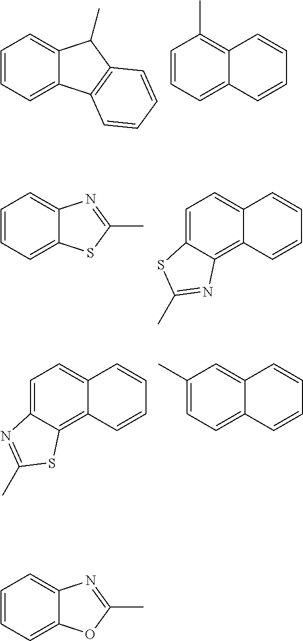

Specific examples of the above-mentioned R^{h} may further have a substituent. Examples of the substituents may include a halogen atom such as a fluorine atom and a chlorine atom; a cyano group; an alkyl group of 1 to 6 carbon atoms such as a methyl group, an ethyl group, and a propyl group; an alkenyl group of 2 to 6 carbon atoms such as a vinyl group and an allyl group; an alkyl halide group of 1 to 6 carbon atoms such as a trifluoromethyl group; an N,N-dialkylamino group of 2 to 12 carbon atoms such as a dimethylamino group; an alkoxy group of 1 to 6 carbon atoms such as a methoxy group, an ethoxy group, and an isopropoxy group; a nitro group; —OCF₃; —C(═O)—R^{b}; —O—C(═O)—R^{b}; —C(═O)—O—R^{b}; and —SO₂R^{a}. The meanings of R^{a} and R^{b} are as described above. Among these, a halogen atom, a cyano group, an alkyl group of 1 to 6 carbon atoms, and an alkoxy group of 1 to 6 carbon atoms are preferable. The number of substituents may be one or plural. The plurality of substituents may be the same as or different from one another.

Rⁱ represents an organic group having one or more aromatic rings selected from the group consisting of an aromatic hydrocarbon ring of 6 to 30 carbon atoms and an aromatic heterocyclic ring of 2 to 30 carbon atoms.

Preferable examples of Rⁱ may include a hydrocarbon ring group of 6 to 40 carbon atoms having one or more aromatic hydrocarbon rings each having 6 to 30 carbon atoms.

Other preferable examples of Rⁱ may include a heterocyclic ring group of 2 to 40 carbon atoms having one or more aromatic rings selected from the group consisting of an aromatic hydrocarbon ring of 6 to 30 carbon atoms and an aromatic heterocyclic ring of 2 to 30 carbon atoms.

Particularly preferable examples of Rⁱ may include the following groups. The meaning of R is as described above.

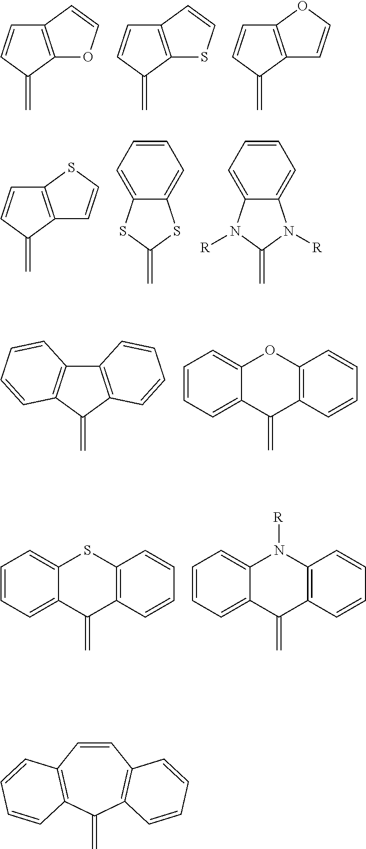

The group represented by any of the formulae (II-1) to (II-7) may further have a substituent other than D¹ to D⁶. Examples of the substituent may include a halogen atom, a cyano group, a nitro group, an alkyl group of 1 to 6 carbon atoms, an alkyl halide group of 1 to 6 carbon atoms, an N-alkylamino group of 1 to 6 carbon atoms, an N,N-dialkylamino group of 2 to 12 carbon atoms, an alkoxy group of 1 to 6 carbon atoms, an alkyl sulfinyl group of 1 to 6 carbon atoms, a carboxyl group, a thioalkyl group of 1 to 6 carbon atoms, an N-alkylsulfamoyl group of 1 to 6 carbon atoms, and an N,N-dialkylsulfamoyl group of 2 to 12 carbon atoms. The number of substituents may be one or plural. The plurality of substituents may be the same as or different from one another.

Preferable examples of Ar in the formula (I) may include groups represented by the following formulae (III-1) to (III-10). The groups represented by the formulae (III-1) to (III-10) may have an alkyl group of 1 to 6 carbon atoms as a substituent. In the following formula, the symbol “*” represents a position for bonding.

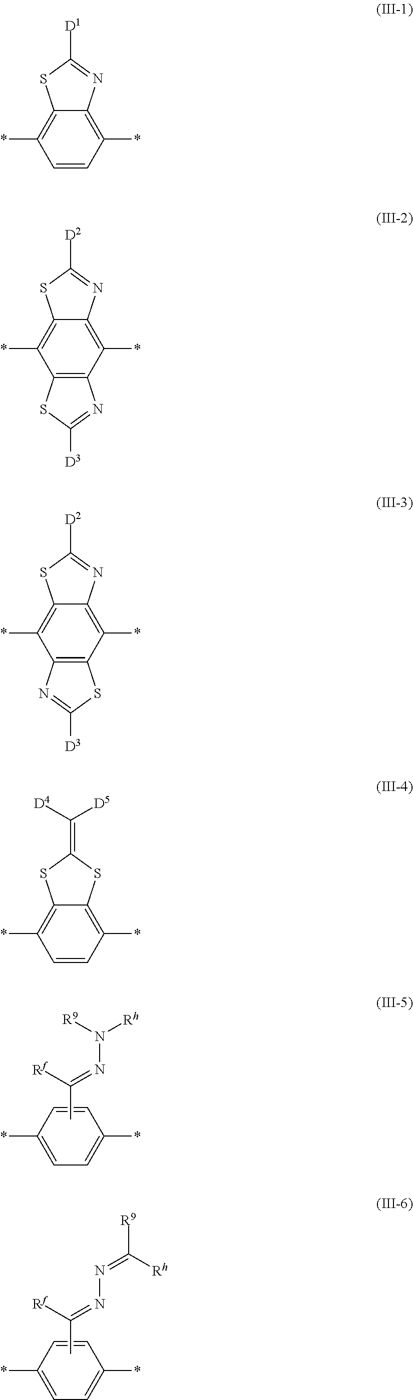

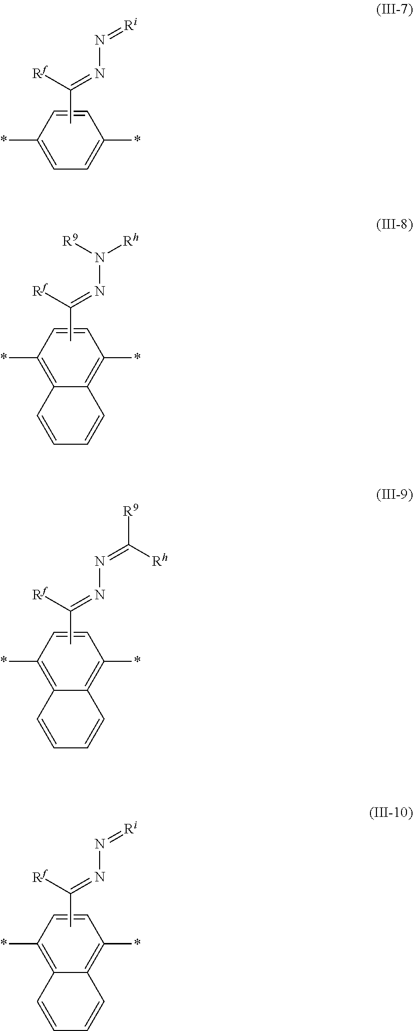

Particularly preferable specific examples of the formulae (III-1) and (III-4) may include the following groups. In the following formula, the symbol “*” represents a position for bonding.

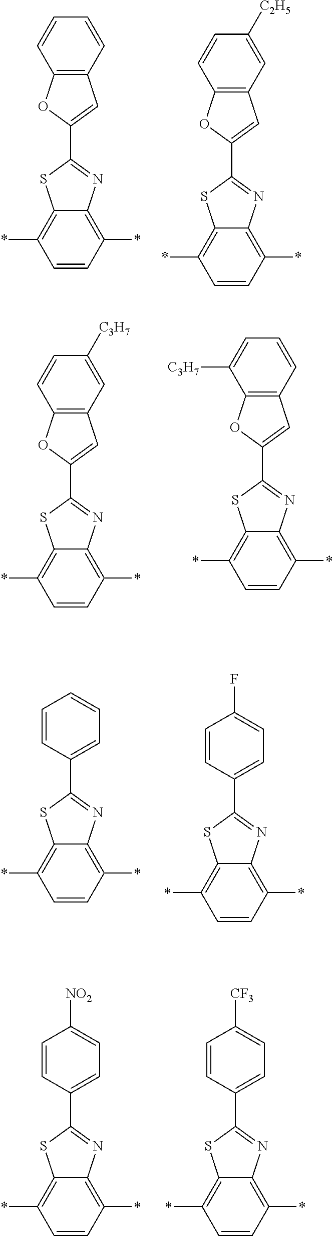

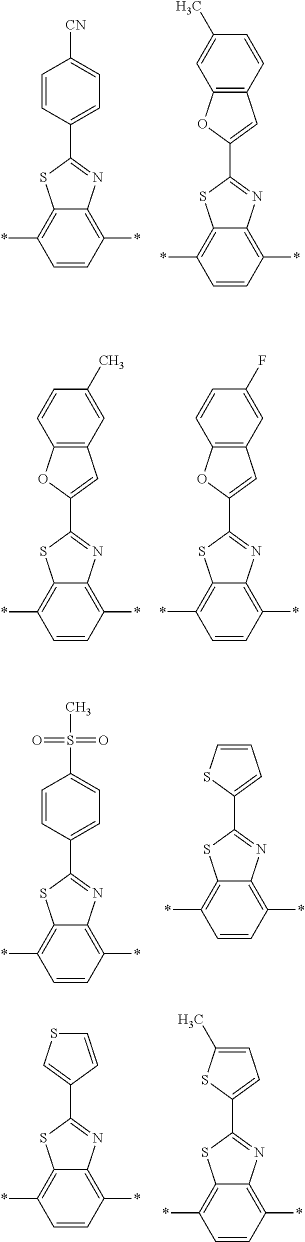

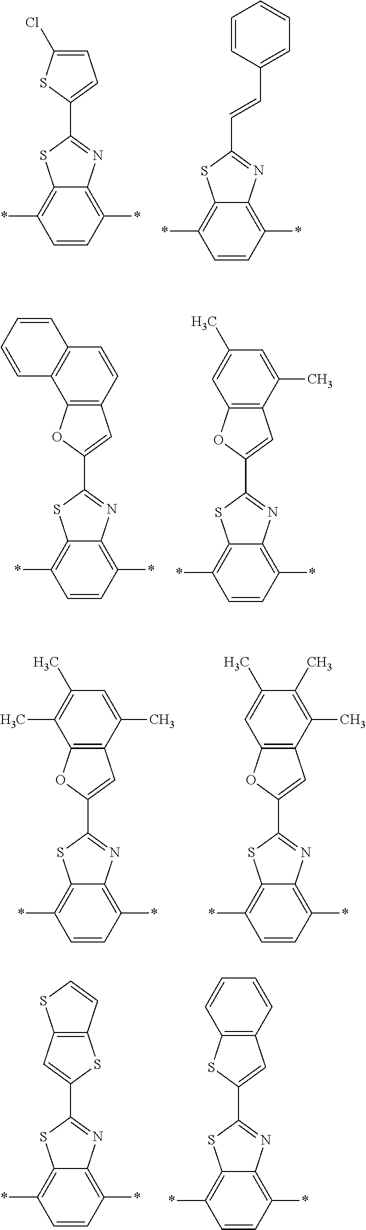

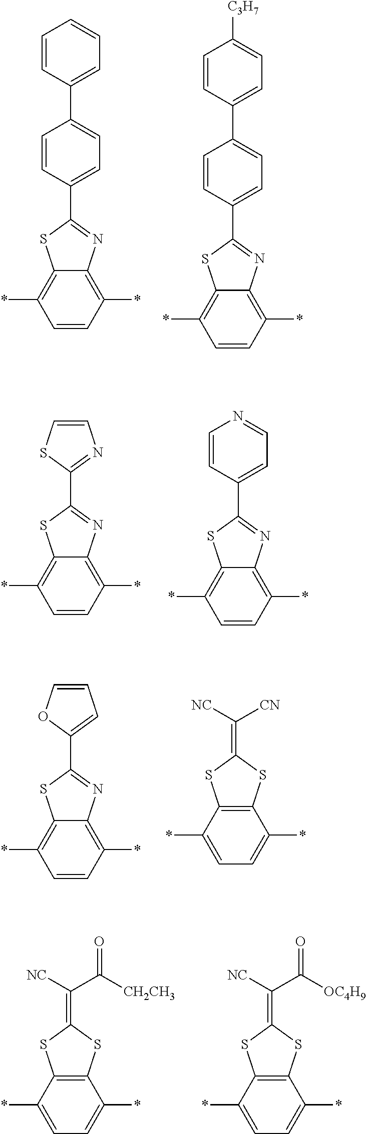

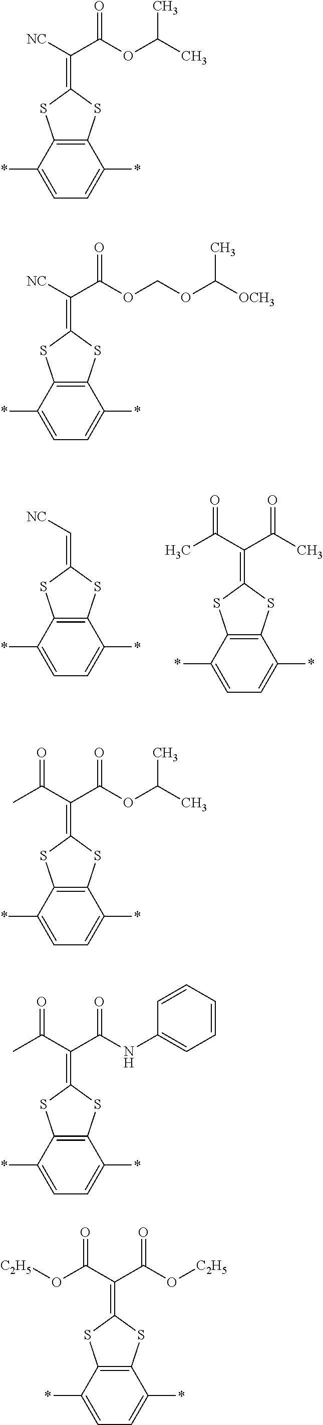

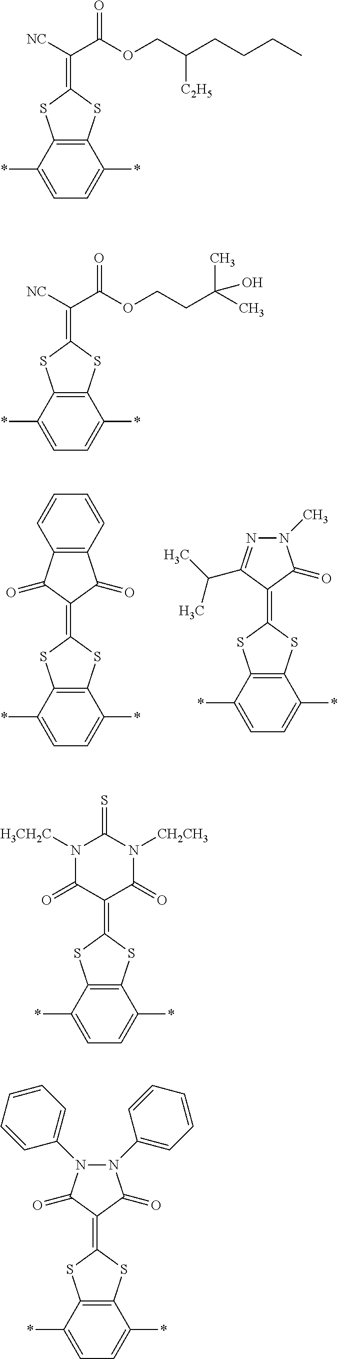

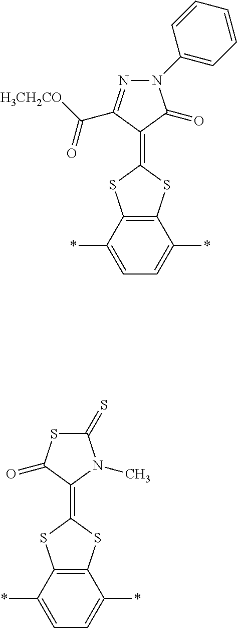

In the formula (I), each of Z² and Z² independently represents one selected from the group consisting of a single bond, —O—, —O—CH₂—, —CH₂—O—, —O—CH₂—CH₂—, —CH₂—CH₂—O—, —C(═O)—O—, —O—C(═O)—, —C(═O)—S—, —S—C(═O)—, —NR²¹—C(═O)—, —C(═O)—NR²¹—, —CF₂—O—, —O—CF₂—, —CH₂—CH₂—, —CF₂—CF₂—, —O—CH₂—CH₂—O—, —CH═CH—C(═O)—O—, —O—C(═O)—CH═CH—, —CH₂—C(═O)—O—, —O—C(═O)—CH₂—, —CH₂—O—C(═O)—, —C(═O)—O—CH₂—, —CH₂—CH₂—C(═O)—O—, —O—C(═O)—CH₂—CH₂—, —CH₂—CH₂—O—C(═O)—, —C(═O)—O—CH₂—CH₂—, —CH═CH—, —N═CH—, —CH═N—, —N═C(CH₃)—, —C(CH₃)═N—, —N═N—, and —C≡C—. Each of R²¹'s independently represents a hydrogen atom or an alkyl group of 1 to 6 carbon atoms.

In the formula (I), each of A¹, A², B¹, and B² independently represents a group selected from the group consisting of a cyclic aliphatic group optionally having a substituent, and an aromatic group optionally having a substituent. Usually the number of carbon atoms of each of the groups represented by A¹, A², B¹, and B² (including the number of carbon atoms of the substituent) is independently 3 to 100. Among these, each of A¹, A², B¹, and B² is independently a cyclic aliphatic group of 5 to 20 carbon atoms optionally having a substituent, or an aromatic group of 2 to 20 carbon atoms optionally having a substituent.

Examples of the cyclic aliphatic groups in A¹, A², B¹ and B² may include a cycloalkanediyl group of 5 to 20 carbon atoms such as a cyclopentane-1,3-diyl group, a cyclohexane-1,4-diyl group, a 1,4-cycloheptane-1,4-diyl group, and a cyclooctane-1,5-diyl group; and a bicycloalkanediyl group of 5 to 20 carbon atoms such as a decahydronaphthalene-1,5-diyl group and a decahydronaphthalene-2,6-diyl group. Among these, an optionally substituted cycloalkanediyl group of 5 to 20 carbon atoms is preferable, a cyclohexanediyl group is more preferable, and a cyclohexane-1,4-diyl group is particularly preferable. The cyclic aliphatic group may be a trans-isomer, a cis-isomer, or a mixture of a cis-isomer and a trans-isomer. Among these, a trans-isomer is more preferable.

Examples of the substituents that the cyclic aliphatic groups in A¹, A², B¹, and B² may have may include a halogen atom, an alkyl group of 1 to 6 carbon atoms, an alkoxy group of 1 to 5 carbon atoms, a nitro group, and a cyano group. The number of substituents may be one or plural. The plurality of substituents may be the same as or different from one another.

Examples of the aromatic groups in A¹, A², B¹, and B² may include an aromatic hydrocarbon ring group of 6 to 20 carbon atoms such as a 1,2-phenylene group, a 1,3-phenylene group, a 1,4-phenylene group, a 1,4-naphthylene group, a 1,5-naphthylene group, a 2,6-naphthylene group, and a 4,4′-biphenylene group; and an aromatic heterocyclic ring group of 2 to 20 carbon atoms such as a furan-2,5-diyl group, a thiophene-2,5-diyl group, a pyridine-2,5-diyl group, and a pyrazine-2,5-diyl group. Among these, an aromatic hydrocarbon ring group of 6 to 20 carbon atoms is preferable, a phenylene group is more preferable, and a 1,4-phenylene group is particularly preferable.

Examples of the substituent that the aromatic groups in A¹, A², B¹ and B² may have may include the same examples as those of the substituent that the cyclic aliphatic groups in A¹, A², B¹ and B² may have. The number of substituents may be one or plural. The plurality of substituents may be the same as or different from one another.

In the formula (I), each of Y¹ to Y⁴ independently represents one selected from the group consisting of a single bond, —O—, —C(═O)—, —C(═O)—O—, —O—C(═O)—, —NR²²—C(═O)—, —C(═O)—NR²²—, —O—C(═O)—O—, —NR²²—C(═O)—O—, —O—C(═O)—NR²²—, and —NR²²—C(═O)—NR²³—. Each of R²² and R²³ independently represents a hydrogen atom or an alkyl group of 1 to 6 carbon atoms.

In the formula (I), each of G¹ and G² independently represents an organic group selected from the group consisting of an aliphatic hydrocarbon group of 1 to 20 carbon atoms; and a group in which one or more of the methylene groups (—CH₂—) contained in the aliphatic hydrocarbon group of 3 to 20 carbon atoms is substituted with —O— or —C(═O)—. The hydrogen atom contained in the organic group of G¹ and G² may be substituted with an alkyl group of 1 to 5 carbon atoms, an alkoxy group of 1 to 5 carbon atoms, or a halogen atom. However, the methylene groups (—CH₂—) at both ends of G¹ and G² are not substituted with —O— or —C(═O)—.

Specific examples of the aliphatic hydrocarbon group of 1 to 20 carbon atoms in G¹ and G² may include an alkylene group of 1 to 20 carbon atoms.

Specific examples of the aliphatic hydrocarbon group of 3 to 20 carbon atoms in G¹ and G² may include an alkylene group of 3 to 20 carbon atoms.

In the formula (I), each of P¹ and P² independently represents a polymerizable functional group. Examples of the polymerizable functional groups for P¹ and P² may include a group represented by CH₂═CR³¹—C(═O)—O— such as an acryloyloxy group and a methacryloyloxy group; a vinyl group; a vinyl ether group; a p-stilbene group; an acryloyl group; a methacryloyl group; a carboxyl group; a methylcarbonyl group; a hydroxyl group; an amido group; an alkylamino group of 1 to 4 carbon atoms; an amino group; an epoxy group; an oxetanyl group; an aldehyde group; an isocyanate group; and a thioisocyanate group. R³¹ represents a hydrogen atom, a methyl group, or a chlorine atom. Among these, a group represented by CH₂═CR³¹—C(═O)—O— is preferable, CH₂═CH—C(═O)—O— (an acryloyloxy group) and CH₂═C(CH₃)—C(═O)—O— (a methacryloyloxy group) are more preferable, and an acryloyloxy group is particularly preferable.

In the formula (I), each of p and q independently represents 0 or 1.

The compound (I) may be produced, for example, by a reaction of a hydrazine compound with a carbonyl compound as described in International Publication No. 2012/147904.

Specific examples of the polymerizable liquid crystal compound (A) may include compounds represented by the following formulae.

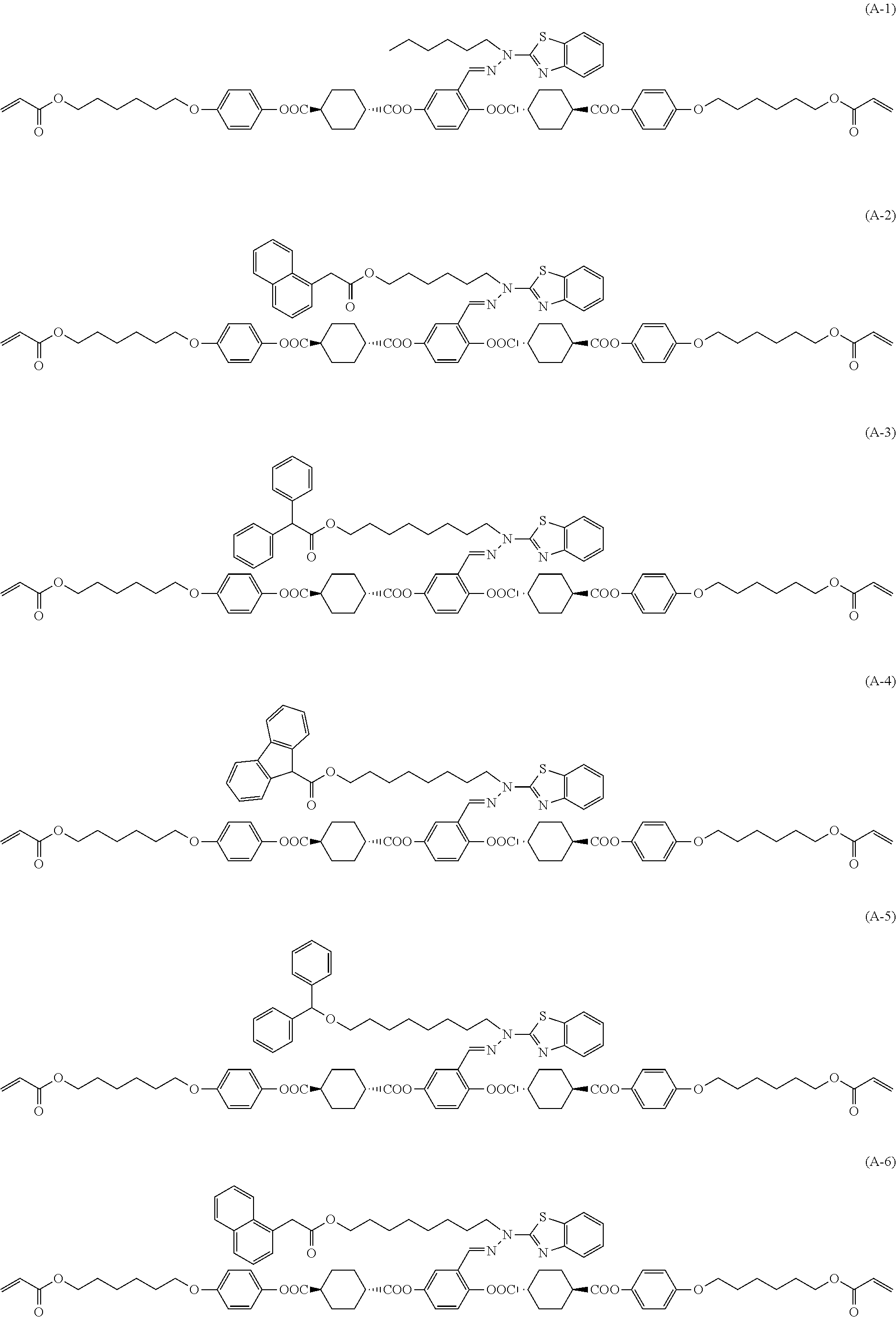

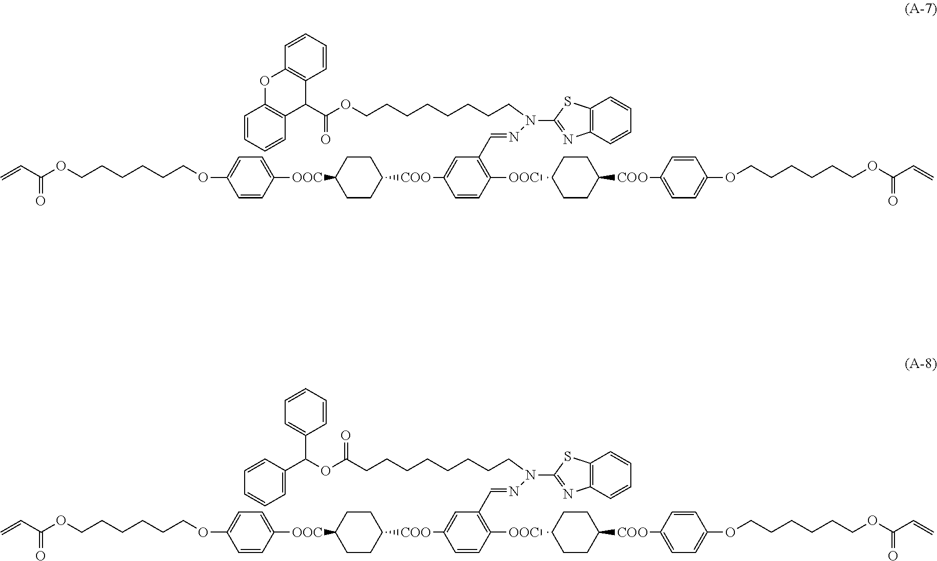

The wavelength λₐ₁ of the polymerizable liquid crystal compound (A) satisfies the aforementioned formula (i).

When the composition of the present invention includes a plurality of types of polymerizable liquid crystal compounds (A), the wavelength λₐ₁ of at least one polymerizable liquid crystal compound among them satisfies the aforementioned formula (i).

In the aforementioned formula (i), the value of |λₐ₁−λ_{b1}| is usually 0 or more.

The value of |λₐ₁−λ_{b1}| is preferably 20 nm or less, preferably 19 nm le less, and still more preferably 16 nm or less.

The polymerizable liquid crystal compound (A) preferably satisfies the following formulae (iii) and (iv).

300 nm≤λₐ₁≤355 nm (iii)

5000 cm²/mol≤Aₐ≤25000 cm²/mol (iv)

Aₐ represents the average molar absorption coefficient of the polymerizable liquid crystal compound (A) in the range of 300 nm or more and 355 nm or less.

λₐ₁ is preferably 340 nm or more, more preferably 345 nm or more, and still more preferably 350 nm or less, and is preferably 354 nm or less, more preferably 353 nm or less, and still more preferably 352 nm or less.

Aₐ is preferably 6000 cm²/mol or more, more preferably 6500 cm²/mol or more, and still more preferably 7000 cm²/mol or more, and is preferably 24000 cm²/mol or less, more preferably 23500 cm²/mol or less, and still more preferably 23000 cm²/mol or less.

When the composition of the present invention contains a plurality of types of polymerizable liquid crystal compounds (A), at least one type of them preferably satisfies the aforementioned formulae (iii) and (iv).

The amount of the polymerizable liquid crystal compound (A) in the composition is preferably 1% by weight or more, more preferably 5% by weight or more, and still more preferably 10% by weight or more, and is preferably 85% by weight or less, more preferably 80% by weight or less, and still more preferably 60% by weight or less.

[Photopolymerization Initiator (B)]

The photopolymerization initiator refers to an agent that exhibits a polymerization initiating action for initiating polymerization of a polymerizable compound by irradiation with light. Light for causing the photopolymerization initiator to exhibit a polymerization initiating action includes ultraviolet light, visible light, infrared light, and other energy rays. The photopolymerization initiator (B) is preferably a photopolymerization initiator capable of exhibiting a polymerization initiation action by irradiation with ultraviolet light.

Examples of the photopolymerization initiator (B) may include an O-acyloxime compound, an α-aminoalkylphenone compound, an acylphosphine oxide compound, a titanocene compound, a thioxanthone compound, an α-hydroxyalkylphenone compound, a biimidazole compound, and a triazine compound.

Among the photopolymerization initiators (B), an O-acyloxime compound is preferable.

Specific examples of the O-acyloxime compound that may be used as the photopolymerization initiator (B) may include 1-[4-(phenylthio)phenyl]-1,2-octanedione 2-(O-benzoyloxime), 1-[9-ethyl-6-(2-methylbenzoyl)-9H-carbazol-3-yl]-ethanone 1-(O-acetyloxime), 1-[9-ethyl-6-(2-methyl-4-tetrahydrofuranylmethoxybenzoyl)-9H-carbazol-3-yl]-ethanone 1-(O-acetyloxime), 1-[9-ethyl-6-{2-methyl-4-(2,2-dimethyl-1,3-dioxolanyl)methoxybenzoyl}-9H-carbazol-3-yl]-ethanone 1-(O-acetyloxime), and 1-[4-[3-[4-[[2-(acetyloxy)ethyl]sulfonyl]-2-methylbenzoyl]-6-[1-[(acetyloxy)imino]ethyl]-9H-carbazol]-9-yl]phenyl 1-octanone 1-(O-acetyloxime).

Commercially available products may be used as the O-acyloxime compound. Examples of the commercially available products may include “NCI-700”, “NCI-730”, “NCI-831”, and “NCI-930” (manufactured by ADEKA Corporation), “DFI-020” and “DFI-091” (manufactured by Daito Chemix Co., Ltd.); and “Irgacure OXE03” and “Irgacure OXE04” (manufactured by BASF).

The composition of the present invention may contain one type of photopolymerization initiator (B) solely or a combination of two or more types thereof at any ratio.

When the composition of the present invention includes a plurality of types of photopolymerization initiators (B), as long as the wavelength λ_{b1} of at least one type of photopolymerization initiator (B) among them satisfies the aforementioned formula (i), the wavelength λ_{b1} of the other photopolymerization initiators (B) may not satisfy the aforementioned formula (i).

The photopolymerization initiator (B) preferably satisfies the following formulae (v) and (vi).

300 nm≤λ_{b1}≤355 nm (v)

10000 cm²/mol≤A_{b}≤25000 cm²/mol (vi)

A_{b} represents the average molar absorption coefficient of the photopolymerization initiator (B) in the range of 300 nm or more and 355 nm or less.

λ_{b1} is preferably 325 nm or more, more preferably 328 nm or more, and still more preferably 331 nm or more, and is preferably 350 nm or less, more preferably 345 nm or less, and still more preferably 340 nm or less.

A_{b} is preferably 10000 cm²/mol or more, more preferably 11000 cm²/mol or more, and still more preferably 12000 cm²/mol or more, and is preferably 25000 cm²/mol or less, more preferably 24500 cm²/mol or less, and still more preferably 24000 cm²/mol or less.

When the composition of the present invention contains a plurality of types of photopolymerization initiators (B), at least one type among them preferably satisfies the aforementioned formulae (v) and (vi).

The weight ratio of the photopolymerization initiator (B) relative to the polymerizable liquid crystal compound (A) in the composition is preferably 1/100 or more, more preferably 2/100 or more, and still more preferably 3/100 or more, and is preferably 14/100 or less, more preferably 12/100 or less, and still more preferably 10/100 or less.

[Crosslinking Agent (C)]

A crosslinking agent refers to an agent capable of forming crosslinking bonds on a polymerizable compound. The crosslinking agent does not include the polymerizable liquid crystal compound (A).

The composition of the present invention may contain one type of crosslinking agent (C) solely or a combination of two or more types thereof at any ratio.

The crosslinking agent (C) is preferably a polyfunctional monomer. The polyfunctional monomer means a compound having two or more polymerizable groups in one molecule.

Examples of the polymerizable groups that the multifunctional monomer may have may include a (meth)acryloyl group, an epoxy group, and a vinyl group.

Examples of the multifunctional monomer may include a bifunctional monomer (for example, tricyclodecanedimethanol di(meth)acrylate, triethylene glycol diacrylate), and a multifunctional monomer having three or more functional groups (for example, pentaerythritol tetra(meth)acrylate, dipentaerythritol hexa(meth)acrylate, propoxylated dipentaerythritol hexa(meth)acrylate, and pentaerythritol triacrylate).

The crosslinking agent is more preferably a bifunctional monomer. A bifunctional monomer means a compound having two polymerizable groups in one molecule. By using the bifunctional monomer, orientation disorder of the polymerizable liquid crystal compound (A) can be suppressed, and a phase difference film in which orientation defects are suppressed can be obtained.

The crosslinking agent (C) is preferably a compound having an alicyclic structure, more preferably a bifunctional monomer having an alicyclic structure.

Examples of the alicyclic structure may include a monocyclic alicyclic structure (for example, a cyclopentane ring, a cyclohexane ring, a cycloheptane ring, and a cyclooctane ring), and a polycyclic alicyclic structure of two or more rings (for example, a bicycloheptane ring, a tricyclodecane ring, and a bicyclodecane ring).

Specific examples of the crosslinking agent (C) may include compounds represented by the following formulae.

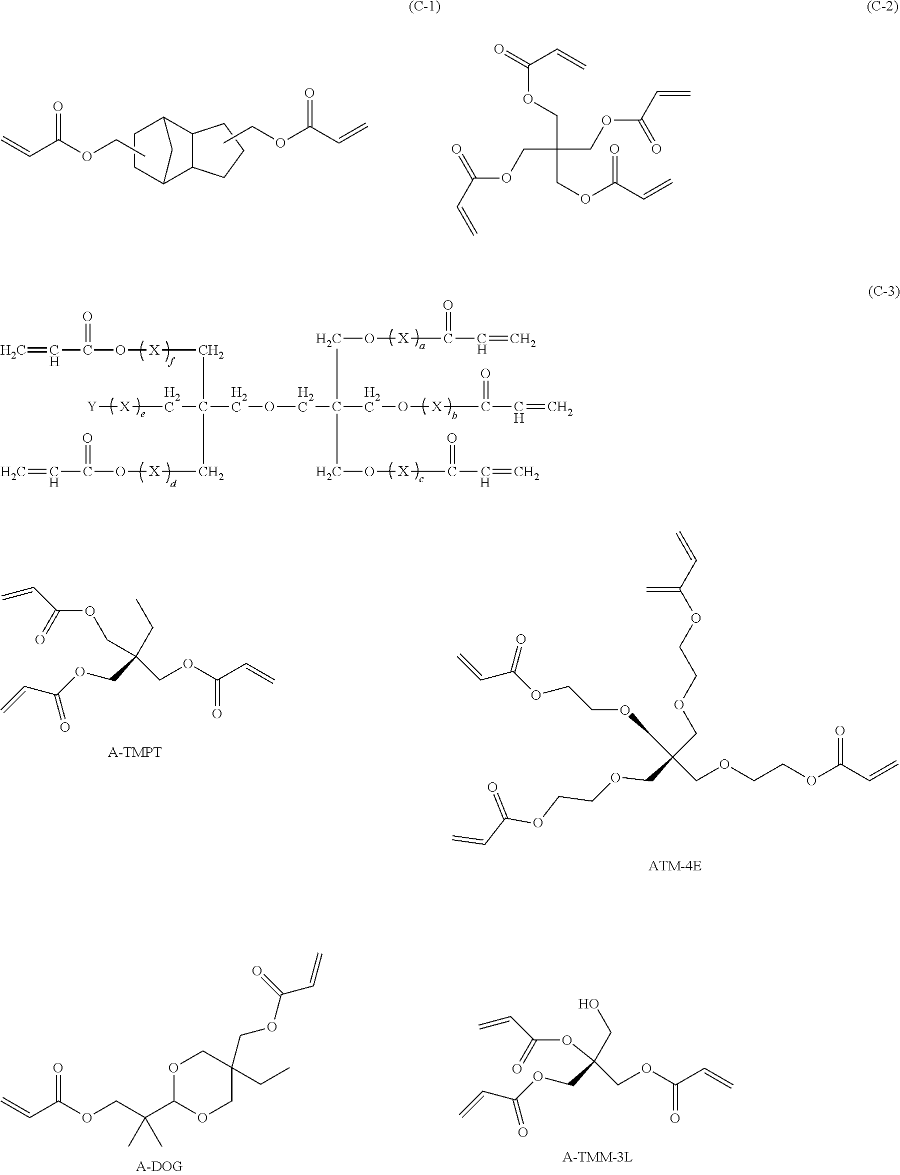

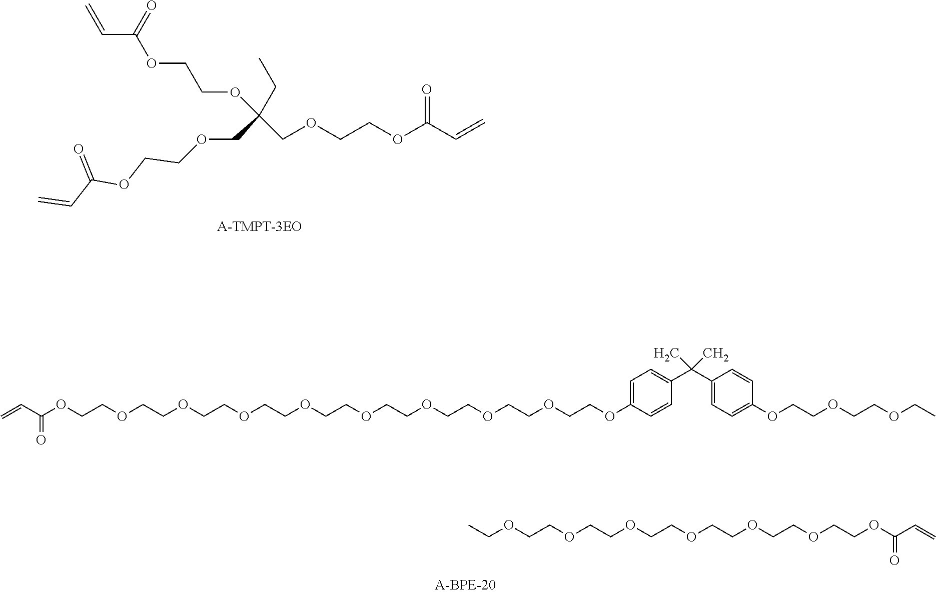

In the aforementioned formula (C-3), each of a, b, c, d, e, and f independently represents an integer of 1 or more and 2 or less. Y represents an acryloyl group or a hydroxy group. X is a group represented by the following formula:

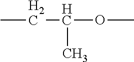

Y is preferably an acryloyl group. The compound represented by the formula (C-3) wherein Y is an acryloyl group is referred to as a propoxylated dipentaerythritol hexaacrylate.

The wavelength λ_{c1} of the crosslinking agent (C) satisfies the aforementioned formula (ii).

In the light absorption spectrum of the crosslinking agent (C) of 200 nm or more and 500 nm or less, when there are two or more absorption local maxima, as long as at least one of the two or more absorption local maxima satisfies the aforementioned formula (ii), the other absorption local maxima may not satisfy the aforementioned formula (ii).

When the composition of the present invention includes a plurality of types of crosslinking agents (C), as long as the wavelength λ_{c1} of at least one type of crosslinking agent (C) among them satisfies the aforementioned formula (ii), the wavelength λ_{c1} of the other crosslinking agents (C) may not satisfy the aforementioned formula (ii).

The wavelength λ_{c1} is usually 200 nm or more.

The crosslinking agent (C) satisfies the following formula (vii).

A_{c}<Aₐ and A_{c}<A_{b} (vii)

In the aforementioned formula (vii), Aₐ has the same meaning as the one for the aforementioned formula, A_{b} has the same meaning as the one for the aforementioned formula, and A_{c} represents the average molar absorption coefficient (cm²/mol) of the crosslinking agent (C) in the range of 300 nm or more and 355 nm or less.

The viscosity of the crosslinking agent (C) at 25° C. is preferably 100 mPa·s or more and 500 mPa·s or less, and more preferably 100 mPa·s or more and 350 mPa·s or less. By using the crosslinking agent (C) having a viscosity in the aforementioned range, orientation disorder of the polymerizable liquid crystal compound (A) can be suppressed, and a phase difference film in which orientation defects are suppressed can be obtained.

Viscosity may be measured, for example, by an “EMS-1000” EMS viscometer manufactured by Kyoto Electronics Manufacturing Co., Ltd. under the conditions of a rotational speed of 700 rpm and a spherical probe diameter of 2 mm.

The weight ratio of the crosslinking agent (C) relative to the polymerizable liquid crystal compound (A) in the composition is preferably 1/100 or more, more preferably 3/100 or more, and still more preferably 5/100 or more, and is preferably 30/100 or less, more preferably 25/100 or less, and still more preferably 20/100 or less.

The composition may contain an optional component in addition to the aforementioned polymerizable liquid crystal compound (A), photopolymerization initiator (B), and crosslinking agent (C). Examples of such optional components may include a solvent, a surfactant, and an ultraviolet absorber.

The solvent that may be included in the composition is usually an organic solvent. Examples of the organic solvent that may be included in the composition may include a hydrocarbon solvent such as cyclopentane and cyclohexane; a ketone solvent such as cyclopentanone, cyclohexanone, methyl ethyl ketone, acetone, methyl isobutyl ketone, and N-methylpyrrolidone; an acetic acid ester solvent such as butyl acetate and amyl acetate; a halogenated hydrocarbon solvent such as chloroform, dichloromethane, and dichloroethane; an ether solvent such as 1,4-dioxane, cyclopentylmethyl ether, tetrahydrofuran, tetrahydropyran, 1,3-dioxolane, and 1,2-dimethoxyethane; and an aromatic hydrocarbon solvent such as toluene, xylene, and mesitylene.

The boiling point of the solvent is preferably 60° C. to 250° C., and more preferably 60° C. to 150° C., from the viewpoint of excellent handling property. As the solvent, one type thereof may be solely used, and two or more types thereof may also be used in combination at any ratio.

The ratio of the solvent in the composition is preferably 100 parts by weight or more and 1000 parts by weight or less relative to 100 parts by weight of the polymerizable liquid crystal compound (A).

As a surfactant that may be included in the composition, a nonionic surfactant is preferable. Specific examples of the nonionic surfactant may include “Megaface” series manufactured by DIC Corporation and the “Surflon” series manufactured by AGC Seimi Chemical Corporation. As the surfactant, one type thereof may be solely used, and two or more types thereof may also be used in combination at any ratio.

The ratio of the surfactant in the composition is preferably 0.01 part by weight or more and 10 parts by weight or less, more preferably 0.1 part by weight or more and 2 parts by weight or less, relative to 100 parts by weight of the polymerizable liquid crystal compound (A).

The ratio of each of the other optional components in the composition is preferably 0.1 part by weight or more and 20 parts by weight or less relative to 100 parts by weight of the polymerizable liquid crystal compound (A).

[2. Phase Difference Film]

A phase difference film, which can function as a 1/4λ plate or the like, may be produced by forming a layer of the aforementioned composition, giving orientation to the polymerizable liquid crystal compound (A), and curing.

The phase difference film is formed of preferably a cured product obtained by curing the aforementioned composition, more preferably a cured product obtained by curing the aforementioned composition with ultraviolet light, further preferably a cured product obtained by curing the aforementioned composition with ultraviolet light from a mercury lamp (for example, “mercury lamp” manufactured by Eye Graphics Co., Ltd.).

The retardation Re at 590 nm of the phase difference film is preferably more than 100 nm and less than 180 nm.

The retardation Re at 590 nm of the phase difference film is more preferably 130 nm or more, and still more preferably 135 nm or more, and is more preferably 150 nm or less, and still more preferably 147 nm or less.

The aforementioned phase difference film preferably satisfies the following formula (viii).

|Δn0−Δn1|<0.025 nm (viii)

In the aforementioned formula,

Δn1 represents a birefringence at 590 nm of the phase difference film, and

Δn0 represents a birefringence at 590 nm of a film formed of a cured product obtained by curing, with ultraviolet light, a composition (X₀) that is a composition omitting the crosslinking agent (C) from the aforementioned composition (hereinafter, also referred to as a composition (X)).

The absolute value |Δn0−Δn1| of a difference between a birefringence Δn1 and a birefringence Δn0 is preferably less than 0.025 nm, more preferably 0.023 nm or less, and still more preferably 0.022 nm or less, and is usually 0 nm or more.

In general, when a composition including a polymerizable liquid crystal compound and a photopolymerization initiator further includes a crosslinking agent, the birefringence Δn of a phase difference film produced with the composition tends to decrease. However, the birefringence Δn1 of a phase difference film produced with the composition (X) of the present invention does not significantly decrease compared to the birefringence Δn0 of a phase difference film produced with a composition (X₀) that is a composition omitting the crosslinking agent (C) from the composition (X). Furthermore, the phase difference film produced with the composition (X) of the present invention shows a small absolute value of a change rate of retardation Re before and after a thermal durability test.

The value of |Δn0−Δn1| being less than 0.025 nm can be achieved when a phase difference film is formed of the composition (X) that includes a specific polymerizable liquid crystal compound (A), a specific photopolymerization initiator (B), and a specific crosslinking agent (C) as described in the aforementioned section [1. Composition].

The phase difference film may be combined with an optional layer to constitute an optical layered body including the optional layer and the phase difference film. Examples of the optional layer may include a tackiness layer and an adhesive layer.

[3. Method for Producing Phase Difference Film]

The aforementioned phase difference film may be produced by, for example, a method including the following steps (1) to (3) in this order.

Step (1): a step of drying a composition layer formed of a composition including the polymerizable liquid crystal compound (A), the photopolymerization initiator (B), and the crosslinking agent (C)

Step (2): a step of irradiating the dried composition layer with ultraviolet light to obtain a cured layer

Step (3): a step of subjecting the cured layer to a heating treatment

[Step (1)]

In step (1), a composition layer formed of the composition including a polymerizable liquid crystal compound (A), a photopolymerization initiator (B), and a crosslinking agent (C) is dried.

Herein, examples and preferable examples of the composition including the polymerizable liquid crystal compound (A), the photopolymerization initiator (B), and the crosslinking agent (C) are the same as those described in the aforementioned section [1. Composition].

The composition layer may be formed by, for example, applying the composition onto a surface of a coating substrate. The coating substrate may be preliminary subjected to a treatment for imparting orientation regulating force to its surface. Examples of such a treatment may include a rubbing treatment, an orientation layer forming treatment, an ion beam orientating treatment, and a stretching treatment. Among these, a stretching treatment is preferable.

Examples of a method for applying the composition onto a surface of a coating substrate may include a curtain coating method, an extrusion coating method, a roll coating method, a spin coating method, a dip coating method, a bar coating method, a spray coating method, a slide coating method, a print coating method, a gravure coating method, a die coating method, a gap coating method, and a dipping method.

Examples of the method for drying the composition layer may include air drying, heat drying, vacuum drying, and vacuum heat drying. By drying the composition layer, volatile components such as a solvent contained in the composition layer can be removed.

[Step (2)]

In step (2), the dried composition layer is irradiated with ultraviolet light to obtain a cured layer. By irradiating the composition layer with ultraviolet light, the composition layer is cured to form a cured layer.

The integrated light quantity of ultraviolet light is preferably 500 mJ/cm² or more, and more preferably 600 mJ/cm² or more, and is preferably 1000 mJ/cm² or less, and more preferably 900 mJ/cm² or less.

Examples of a light source of ultraviolet light may include a mercury lamp (for example, “mercury lamp” manufactured by Eye Graphics Co., Ltd.) and “H bulb” manufactured by Heraeus K.K., and a mercury lamp is preferable.

[Step (3)]

In step (3), the cured layer is subjected to a heating treatment. The temperature in the heating treatment is preferably 65° C. or higher, more preferably 70° C. or higher, and still more preferably 75° C. or higher, and is preferably 90° C. or lower, more preferably 88° C. or lower, and still more preferably 85° C. or lower. The duration of the heating treatment is preferably 5 hours or more, more preferably 12 hours or more, and still more preferably 24 hours or more, and is preferably 216 hours or less, more preferably 144 hours or less, and still more preferably 96 hours or less.

By subjecting the cured layer to a heating treatment, thermal durability of the obtained phase difference film can be further improved.

The method for producing the phase difference film may include an optional process other than the aforementioned steps (1) to (3). Examples of the optional process may include a process of, before step (1), applying the composition onto a surface of a coating substrate to form a composition layer, and a process of, after step (2), peeling the formed cured layer from the coating substrate.

### EXAMPLES

Hereinafter, the present invention will be specifically described by illustrating Examples. However, the present invention is not limited to the Examples described below. The present invention may be optionally modified for implementation without departing from the scope of claims of the present invention and its equivalents. In the following description, “%” and “part” representing quantity are on the basis of weight, unless otherwise specified. The operation described below was performed under the conditions of normal temperature and normal pressure in the atmospheric air, unless otherwise specified.

[Evaluation Method]

### [Light Absorption Spectrum]

The light absorption spectrum of each component constituting the composition was measured using “V-500” manufactured by Jasco Corporation. The measurement wavelength range was 200 nm or more and 500 nm or less.

From the light absorption spectrum, absorption local maxima were detected. Among the detected absorption local maxima, a wavelength of an absorption local maximum on the longest wavelength side was defined as λₐ₁ for the polymerizable liquid crystal compound (A), λ_{b1} for the photopolymerization initiator (B), and λ_{c1} for the crosslinking agent (C). When only one absorption local maximum exists in the range of 200 nm or more and 500 nm or less, the wavelength of this absorption local maximum is defined as λₐ₁, λ_{b1} or λ_{c1}.

As an average molar absorption coefficient in the range of 300 nm or more and 355 nm or less of each component, a molar absorption coefficient was calculated from a molar concentration of each component and an optical path length (1 cm) used in the measurement, and an average in the range of 300 nm or more and 355 nm or less was obtained.

[Retardation and Birefringence]

The retardation Re at 590 nm of the phase difference film was measured using “AxoScan” manufactured by Axometrics Inc. From the measured retardation Re and thickness d (nm) of the phase difference film, a birefringence Δn was calculated by the following formula.

Δn=Re/d

[Thickness]

The thickness of the film was obtained by a film thickness measuring device (“Filmetrics” manufactured by Filmetrics, Inc.).

[Thermal Durability]

The thermal durability of the phase difference film was tested in the following manner.

### Thermal Durability of Examples 1 to 8 and Comparative Examples 1 and 2

The phase difference film formed on a substrate was bonded to a slide glass provided with a tackiness agent (the tackiness agent: “CS9621T” manufactured by Nitto Denko Corporation). After that, the substrate was peeled to prepare a test piece, and the retardation Re (0 hr) of the phase difference film of the test piece was measured.

The test piece was placed in a temperature control bath at 85° C. After 100 hours therefrom, the test piece was taken out of the temperature control bath to measure the retardation Re (100 hr) of the phase difference film of the test piece.

A change rate ΔRe (%) of Re was calculated by the following formula. The smaller the absolute value of ΔRe (%), the higher the thermal durability of the phase difference film.

ΔRe(%)═(Re(100 hr)−Re(0 hr))/Re(0 hr)×100

### Thermal Durability of Examples 9 to 15

By the same manner as the previous description, a test piece was prepared, and the retardation Re(0 hr) of the test piece was measured. The test piece was placed in a temperature control bath at 85° C. After 500 hours therefrom, the test piece was taken out of the temperature control bath, and the retardation Re (500 hr) of the phase difference film of the test piece was measured. The change rate ΔRe(500 hr) (%) of Re was calculated by the following formula.

ΔRe(500 hr) (%)═(Re(500 hr)−Re(0 hr))/Re(0 hr)×100

[Viscosity of Crosslinking Agent]

As the viscosity at 25° C. of the crosslinking agent used in each of Examples 9 to 15, a catalog value of Shin-Nakamura Chemical Co., Ltd. was used.

### Example 1

### (1-1. Preparation of Composition)

A composition (X1) was prepared by mixing 19.18 parts of a compound represented by the following formula (A-1) as a polymerizable liquid crystal compound, 1.92 parts (10 parts relative to 100 parts of the polymerizable liquid crystal compound) of a crosslinking agent (trade name “NK Ester A-DCP”, manufactured by Shin-Nakamura Chemical Co., Ltd., a compound represented by the aforementioned formula (C-1)), 0.06 part of a surfactant (trade name “Megaface F-562”, manufactured by DIC Corporation), 0.84 part (4 parts relative to 100 parts of the polymerizable liquid crystal compound) of a photopolymerization initiator (trade name “Adeka Arkls NCI-730”, manufactured by ADEKA Corporation), and 78 parts of a mixed solvent of cyclopentanone and 1,3-dioxolane. The compound represented by the following formula (A-1) is a polymerizable liquid crystal compound having a reverse wavelength dispersion property.

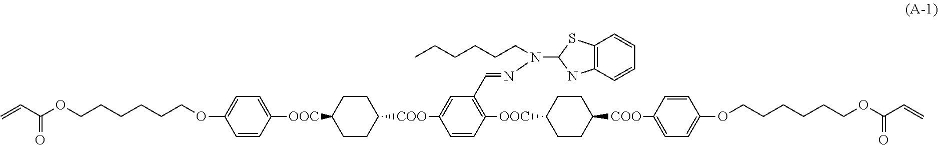

(1-2. Production of Pre-Stretch Substrate)

Pellets of a thermoplastic norbornene resin (manufactured by ZEON Corporation, Tg 126° C.), which is a resin containing a polymer having an alicyclic structure, were dried at 90° C. for 5 hours. The dried pellets were supplied to an extruder, melted in the extruder, passed through a polymer pipe and a polymer filter, extruded into a sheet shape from a T die onto a casting drum, cooled, and taken up while protected with a masking film (“FF1025” manufactured by Tredegar Corporation), thereby to obtain a roll of a pre-stretch substrate having a thickness of 80 and a width of 1490 mm.

(1-3. Production of Substrate)

The pre-stretch substrate was drawn off the roll of a pre-stretch substrate obtained in (1-2), continuously supplied to a tenter stretching machine while the masking film was peeled, diagonally stretched such that the slow axis of the substrate film became 45° relative to the widthwise direction (45° relative to the lengthwise direction), and trimmed at both ends in the widthwise direction of the substrate film, thereby to obtain a long-length substrate having a width of 1350 mm. The obtained substrate had an Re of 143 nm and a film thickness of 77 The obtained substrate was taken up while protected with another masking film (“FF1025” manufactured by Tredegar Corporation), thereby to obtain a roll of the substrate.

(1-4. Formation of Composition Layer)

The substrate was drawn off the roll of the substrate obtained in (1-3), and conveyed while the masking film was peeled. At a room temperature of 25° C., the composition (X1) obtained in (1-1) was directly applied onto one surface (a surface to which the masking film had been bonded) of the conveyed substrate using a die coater, thereby to form a layer of the composition (X1).

(1-5. Drying Process (Orientating Treatment))

The layer of the composition formed in (1-4) on the substrate was dried at 110° C. for 2.5 minutes. Accordingly, the layer of the composition on the substrate was subjected to orientating treatment.

(1-6. Formation (Polymerization) of Cured Layer)

After that, under nitrogen atmosphere, the layer of the composition dried in (1-5) was irradiated with ultraviolet light at an integrated illuminance of equal to or more than 700 mJ/cm² (irradiation intensity: 350 mW/cm², irradiation duration: 2 seconds) by a “mercury lamp” manufactured by Eye Graphics Co., Ltd. Accordingly, the polymerizable liquid crystal compound in the composition was polymerized to form cured liquid crystal molecules. In this manner, there was obtained a cured layer with a dry film thickness of 2.4 μm that was formed of a cured product of the homogeneously oriented composition. Thus, there was obtained a multilayer film having the layer structure (substrate)/(cured layer).

(1-7. Heating Treatment of Cured Layer)

The multilayer film obtained in (1-6) was heated at 85° C. for 24 hours to subject the cured layer (phase difference film) to a heating treatment.

The retardation Re of the cured layer (phase difference film) after the heating treatment was measured to calculate a birefringence Δn1, and thermal durability was also evaluated. The results are shown in Table 1. Furthermore, an absolute value |Δn0−Δn1| of a difference between Δn0 calculated in the following Reference Example 1 and Δn1 was calculated, and shown in Table 1.

### Reference Example 1

A multilayer film was obtained by the same manner as that of Example 1 except that the amount of the crosslinking agent was 0 part. The retardation Re of the phase difference film constituting the multilayer film was measured to obtain a birefringence Δn0.

### Example 2

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 1.
(1-7. Heating treatment of cured layer) was not performed, and thermal durability of the cured layer (phase difference film) obtained in (1-6) was evaluated.

An absolute value |Δn0−Δn1| of a difference between Δn0 obtained in the following Reference Example 2 and Δn1 was calculated, and shown in Table 1.

### Reference Example 2

A multilayer film was obtained by the same manner as that of Example 2 except that the amount of the crosslinking agent was 0 part. The retardation Re of the phase difference film constituting the multilayer film was measured to obtain a birefringence Δn0.

### Example 3

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 1. An absolute value |Δn0−Δn1| of a difference between Δn0 obtained in the following Reference Example 3 and Δn1 was calculated, and shown in Table 1.
The number of parts of the crosslinking agent added was changed from 1.92 parts to 3.84 parts (20 parts relative to 100 parts of the polymerizable liquid crystal compound), and the number of parts of the photopolymerization initiator added was changed from 0.84 part to 1.53 parts (8 parts relative to 100 parts of the polymerizable liquid crystal compound).
(1-7. Heating treatment of cured layer) was not performed, and thermal durability of the cured layer (phase difference film) obtained in (1-6) was evaluated.

### Reference Example 3

A multilayer film was obtained by the same manner as that of Example 3 except that the amount of the crosslinking agent was 0 part. The retardation Re of the phase difference film constituting the multilayer film was measured to obtain a birefringence Δn0.

### Example 4

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 1. An absolute value |Δn0−Δn1| of a difference between Δn0 obtained in the following Reference Example 4 and Δn1 was calculated, and shown in Table 1.
The photopolymerization initiator was changed from “Adeka Arkls NCI-730” to “Irgacure Oxe04” manufactured by BASF.
(1-7. Heating treatment of cured layer) was not performed, and thermal durability of the cured layer (phase difference film) obtained in (1-6) was evaluated.

### Reference Example 4

A multilayer film was obtained by the same manner as that of Example 4 except that the amount of the crosslinking agent was 0 part. The retardation Re of the phase difference film constituting the multilayer film was measured to obtain a birefringence Δn0.

### Example 5

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 2. An absolute value |Δn0−Δn1| of a difference between Δn0 obtained in the following Reference Example 5 and Δn1 was calculated, and shown in Table 2.
The polymerizable liquid crystal compound was changed from the compound represented by the aforementioned formula (A-1) to a compound represented by the following formula (A-2). The compound represented by the following formula (A-2) is a polymerizable liquid crystal compound having a reverse wavelength dispersion property.
(1-7. Heating treatment of cured layer) was not performed, and thermal durability of the cured layer (phase difference film) obtained in (1-6) was evaluated.

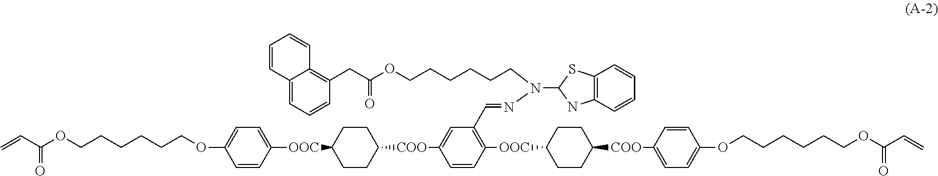

### Reference Example 5

A multilayer film was obtained by the same manner as that of Example 5 except that the amount of the crosslinking agent was 0 part. The retardation Re of the phase difference film constituting the multilayer film was measured to obtain a birefringence Δn0.

### Example 6

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 2. An absolute value |Δn0−Δn1| of a difference between Δn0 obtained in the following Reference Example 6 and Δn1 was calculated, and shown in Table 2.
The crosslinking agent was changed from “NK Ester A-DCP” manufactured by Shin-Nakamura Chemical Co., Ltd. to “NK Ester A-TMMT” (a compound represented by the aforementioned formula (C-2)) manufactured by Shin-Nakamura Chemical Co., Ltd., and the number of parts of the crosslinking agent added was changed from 1.92 parts to 1.34 parts (7 parts relative to 100 parts of the polymerizable liquid crystal compound).
(1-7. Heating treatment of cured layer) was not performed, and thermal durability of the cured layer (phase difference film) obtained in (1-6) was evaluated.

### Reference Example 6

A multilayer film was obtained by the same manner as that of Example 6 except that the amount of the crosslinking agent was 0 part. The retardation Re of the phase difference film constituting the multilayer film was measured to obtain a birefringence Δn0.

### Example 7

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 2. An absolute value |Δn0−Δn1| of a difference between Δn0 obtained in the following Reference Example 7 and Δn1 was calculated, and shown in Table 2.
The crosslinking agent was changed from “NK Ester A-DCP” manufactured by Shin-Nakamura Chemical Co., Ltd. to “NK Ester A-DPH-6P” (propoxylated dipentaerythritol polyacrylate) manufactured by Shin-Nakamura Chemical Co., Ltd., and the number of parts of the crosslinking agent added was changed from 1.92 parts to 0.96 part (5 parts relative to 100 parts of the polymerizable liquid crystal compound).
(1-7. Heating treatment of cured layer) was not performed, and thermal durability of the cured layer (phase difference film) obtained in (1-6) was evaluated.

### Reference Example 7

A multilayer film was obtained by the same manner as that of Example 7 except that the amount of the crosslinking agent was 0 part. The retardation Re of the phase difference film constituting the multilayer film was measured to obtain a birefringence Δn0.

### Example 8

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 2. An absolute value |Δn0−Δn1| of a difference between Δn0 obtained in the following Reference Example 8 and Δn1 was calculated, and shown in Table 2.
The number of parts of the crosslinking agent added was changed from 1.92 parts to 3.84 part (20 parts relative to 100 parts of the polymerizable liquid crystal compound), and the number of parts of the photopolymerization initiator added was changed from 0.84 part to 1.53 parts (8 parts relative to 100 parts of the polymerizable liquid crystal compound).

### Reference Example 8

A multilayer film was obtained by the same manner as that of Example 8 except that the amount of the crosslinking agent was 0 part. The retardation Re of the phase difference film constituting the multilayer film was measured to obtain a birefringence Δn0.

### Comparative Example 1

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 3.
The number of parts of the crosslinking agent added was changed from 1.92 parts to 0 parts.
The photopolymerization initiator was changed from “Adeka Arkls NCI-730” to “Irgacure 379” manufactured by BASF.
(1-7. Heating treatment of cured layer) was not performed, and thermal durability of the cured layer (phase difference film) obtained in (1-6) was evaluated.

### Comparative Example 2

A multilayer film was obtained by the same manner as that of Example 1 except that the following matters were changed, and the retardation Re of the phase difference film constituting the multilayer film was measured to obtain a birefringence Δn1 and thermal durability was also evaluated. The results are shown in Table 3.
The polymerizable liquid crystal compound was changed from the compound represented by the aforementioned formula (A-1) to a compound represented by the aforementioned formula (A-2).
The number of parts of the crosslinking agent added was changed from 1.92 parts to 0 parts.
The photopolymerization initiator was changed from “Adeka Arkls NCI-730” to “Irgacure 379” manufactured by BASF.
(1-7. Heating treatment of cured layer) was not performed, and thermal durability of the cured layer (phase difference film) obtained in (1-6) was evaluated.

### Example 9

A multilayer film was obtained by the same manner as that of Example 5 except that the following matter was changed.
In the formation of the cured layer, the layer of the composition having been subjected to the orienting treatment was irradiated with ultraviolet light at 40° C.

Thermal durability of the phase difference film constituting the obtained multilayer film was evaluated. The oriented surface state of the phase difference film was observed by the following method and evaluated. The results are shown in Table 4.

### (Observation of Oriented Surface State)

Using a polarization microscope, observation was performed at an eyepiece lens magnification of 10 times and an objective lens magnification of 20 times with the “polarizer” and “analyzer” being in a crossed Nichol state. (Evaluation criteria)
A: no opacity visually observed, and no orientation defects microscopically observed
B: no opacity visually observed, and orientation defects microscopically observed
C: opacity visually observed, and orientation defects microscopically observed

### Example 10

A multilayer film was obtained by the same manner as that of Example 9 except that the following matter was changed.
The crosslinking agent was changed from “NK Ester A-DCP” manufactured by Shin-Nakamura Chemical Co., Ltd. to “NK Ester A-TMPT” manufactured by Shin-Nakamura Chemical Co., Ltd.

Thermal durability of the phase difference film constituting the obtained multilayer film was evaluated. The oriented surface state of the phase difference film was observed by the same manner as that of Example 9 and evaluated. The results are shown in Table 4.

### Example 11

A multilayer film was obtained by the same manner as that of Example 9 except that the following matter was changed.
The crosslinking agent was changed from “NK Ester A-DCP” manufactured by Shin-Nakamura Chemical Co., Ltd. to “NK Ester ATM-4E” manufactured by Shin-Nakamura Chemical Co., Ltd.

Thermal durability of the phase difference film constituting the obtained multilayer film was evaluated. The oriented surface state of the phase difference film was observed by the same manner as that of Example 9 and evaluated. The results are shown in Table 4.

### Example 12

A multilayer film was obtained by the same manner as that of Example 9 except that the following matter was changed.
The crosslinking agent was changed from “NK Ester A-DCP” manufactured by Shin-Nakamura Chemical Co., Ltd. to “NK Ester A-DOG” manufactured by Shin-Nakamura Chemical Co., Ltd.

Thermal durability of the phase difference film constituting the obtained multilayer film was evaluated. The oriented surface state of the phase difference film was observed by the same manner as that of Example 9 and evaluated. The results are shown in Table 4.

### Example 13

A multilayer film was obtained by the same manner as that of Example 9 except that the following matter was changed.
The crosslinking agent was changed from “NK Ester A-DCP” manufactured by Shin-Nakamura Chemical Co., Ltd. to “NK Ester A-TMM3L” manufactured by Shin-Nakamura Chemical Co., Ltd.

Thermal durability of the phase difference film constituting the obtained multilayer film was evaluated. The oriented surface state of the phase difference film was observed by the same manner as that of Example 9 and evaluated. The results are shown in Table 5.

### Example 14

A multilayer film was obtained by the same manner as that of Example 9 except that the following matter was changed.
The crosslinking agent was changed from “NK Ester A-DCP” manufactured by Shin-Nakamura Chemical Co., Ltd. to “NK Ester A-TMPT-3E0” manufactured by Shin-Nakamura Chemical Co., Ltd.

Thermal durability of the phase difference film constituting the obtained multilayer film was evaluated.

The oriented surface state of the phase difference film was observed by the same manner as that of Example 9 and evaluated. The results are shown in Table 5.

### Example 15

A multilayer film was obtained by the same manner as that of Example 9 except that the following matter was changed.
The crosslinking agent was changed from “NK Ester A-DCP” manufactured by Shin-Nakamura Chemical Co., Ltd. to “NK Ester A-BPE-20” manufactured by Shin-Nakamura Chemical Co., Ltd.

Thermal durability of the phase difference film constituting the obtained multilayer film was evaluated. The oriented surface state of the phase difference film was observed by the same manner as that of Example 9 and evaluated. The results are shown in Table 5.

In the following Tables,

“A-1” means the compound represented by the formula (A-1),

“A-2” means the compound represented by the formula (A-2),

“A-DCP” means “NK Ester A-DCP” manufactured by Shin-Nakamura Chemical Co., Ltd.,

“A-TMMT” means “NK Ester A-TMMT” manufactured by Shin-Nakamura Chemical Co., Ltd.,

“A-DPH-6P” means “NK Ester A-DPH-6P” manufactured by Shin-Nakamura Chemical Co., Ltd.,

“NCI-730” means “Adeka Arkls NCI-730” manufactured by ADEKA Corporation,

“Number of functional groups” means the number of polymerizable groups (acryloyl groups) contained in one molecule,

“Number of parts added” means the number of parts of a component added relative to 100 parts of the polymerizable liquid crystal compound (A),

“Molar absorption coefficient” means the molar absorption coefficient at the absorption local maximum wavelength λₐ₁, the absorption local maximum wavelength λ_{b1}, or the absorption local maximum wavelength λ_{c1}, and

“Average molar absorption coefficient” means the average molar absorption coefficient in the range of 300 nm or more and 355 nm or less.

TABLE 1

| | Ex. 1 | Ex. 2 | Ex. 3 | Ex. 4 |
|---|---|---|---|---|
| Polymerizable liquid | | | | |
| crystal compound (A) | | | | |
| Type | A-1 | A-1 | A-1 | A-1 |
| Absorption local | 351 | 351 | 351 | 351 |
| maximum wavelength | | | | |
| λₐ₁ (nm) | | | | |
| Molar absorption | 14774 | 14774 | 14774 | 14774 |
| coefficient (cm²/mol) | | | | |
| Average molar | 8438 | 8438 | 8438 | 8438 |
| absorption coefficient | | | | |
| (cm²/mol) | | | | |
| Crosslinking agent (C) | | | | |
| Type | A-DCP | A-DCP | A-DCP | A-DCP |
| Number of functional | 2 | 2 | 2 | 2 |
| groups | | | | |
| Absorption local | 217 | 217 | 217 | 217 |
| maximum wavelength | | | | |
| λ_{c1} (nm) | | | | |
| Molar absorption | 5262 | 5262 | 5262 | 5262 |
| coefficient (cm²/mol) | | | | |
| Average molar | 0 | 0 | 0 | 0 |
| absorption coefficient | | | | |
| (cm²/mol) | | | | |
| Number of parts added | 10 | 10 | 20 | 10 |
| Photopolymerization | | | | |
| initiator (B) | | | | |
| Type | NCI-730 | NCI-730 | NCI-730 | Irgacure |
| | | | | Oxe 04 |
| Absorption local | 337 | 337 | 337 | 332 |
| maximum wavelength | | | | |
| λ_{b1} (nm) | | | | |
| Molar absorption | 18428 | 18428 | 18428 | 28699 |
| coefficient (cm²/mol) | | | | |
| Average molar | 12874 | 12874 | 12874 | 23684 |
| absorption coefficient | | | | |
| (cm²/mol) | | | | |
| Number of parts added | 4 | 4 | 8 | 4 |
| Phase difference film | | | | |
| properties | | | | |
| Δn0 | 0.0642 | 0.0642 | 0.0642 | 0.0649 |
| Δn1 | 0.0587 | 0.0587 | 0.0516 | 0.0588 |
| Δn0 − Δn1 | 0.0055 | 0.0055 | 0.0126 | 0.0061 |
| Re (nm) | 143 | 143 | 143 | 163 |
| Production conditions | | | | |
| UV irradiation | 700 mJ/cm² | 700 mJ/cm² | 700 mJ/cm² | 700 mJ/cm² |
| condition | | | | |
| Heating treatment | 85° C. | No | No | No |
| condition | | | | |
| Re change rate ΔRe | −3.7% | −4.2% | −3.0% | −4.4% |

TABLE 2

| | Ex. 5 | Ex. 6 | Ex. 7 | Ex. 8 |
|---|---|---|---|---|
| Polymerizable liquid | | | | |
| crystal compound (A) | | | | |
| Type | A-2 | A-1 | A-1 | A-1 |
| Absorption local | 351 | 351 | 351 | 351 |
| maximum wavelength | | | | |
| λₐ₁ (nm) | | | | |
| Molar absorption | 39138 | 14774 | 14774 | 14774 |
| coefficient (cm²/mol) | | | | |
| Average molar | 22915 | 8438 | 8438 | 8438 |
| absorption coefficient | | | | |
| (cm²/mol) | | | | |
| Crosslinking agent (C) | | | | |
| Type | A-DCP | A-TMMT | A-DPH-6P | A-DCP |
| Number of functional | 2 | 4 | 6 | 2 |
| groups | | | | |
| Absorption local | 217 | 204 | 205 | 217 |
| maximum wavelength | | | | |
| λ_{c1} (nm) | | | | |
| Molar absorption | 5262 | 3881 | 9741 | 5262 |
| coefficient (cm²/mol) | | | | |
| Average molar | 0 | 0 | 0 | 0 |
| absorption coefficient | | | | |
| (cm²/mol) | | | | |
| Number of parts added | 10 | 7 | 5 | 20 |
| Photopolymerization | | | | |
| initiator (B) | | | | |
| Type | NCI-730 | NCI-730 | NCI-730 | NCI-730 |
| Absorption local | 337 | 337 | 337 | 337 |
| maximum wavelength | | | | |
| λ_{b1} (nm) | | | | |
| Molar absorption | 18428 | 18428 | 18428 | 18428 |
| coefficient (cm²/mol) | | | | |
| Average molar | 12874 | 12874 | 12874 | 12874 |
| absorption coefficient | | | | |
| (cm²/mol) | | | | |
| Number of parts added | 4 | 4 | 4 | 8 |
| Phase difference film | | | | |
| properties | | | | |
| Δn0 | 0.0594 | 0.0642 | 0.0642 | 0.0642 |
| Δn1 | 0.0551 | 0.0527 | 0.0425 | 0.0516 |
| Δn0 − Δn1 | 0.0043 | 0.0115 | 0.0217 | 0.0126 |
| Re (nm) | 143 | 138 | 143 | 143 |
| Production conditions | | | | |
| UV irradiation condition | 700 mJ/cm² | 700 mJ/cm² | 700 mJ/cm² | 700 mJ/cm² |
| Heating treatment | No | No | No | 85° C. |
| condition | | | | |
| Re change rate ΔRe | −3.5% | −5.0% | −3.6% | −2.5% |

TABLE 3

| | Comp. Ex. 1 | Comp. Ex. 2 |
|---|---|---|
| Polymerizable liquid | | |
| crystal compound (A) | | |
| Type | A-1 | A-2 |
| Absorption local | 351 | 351 |
| maximum wavelength | | |
| λₐ₁ (nm) | | |
| Molar absorption | 14774 | 39138 |
| coefficient (cm²/mol) | | |
| Average molar | 8438 | 22915 |
| absorption coefficient | | |
| (cm²/mol) | | |
| Crosslinking agent (C) | | |
| Type | — | — |
| Number of functional | — | — |
| groups | | |
| Absorption local | — | — |
| maximum wavelength | | |
| λ_{c1} (nm) | | |
| Molar absorption | — | — |
| coefficient (cm²/mol) | | |
| Average molar | — | — |
| absorption coefficient | | |
| (cm²/mol) | | |
| Number of parts added | 0 | 0 |
| Photopolymerization | | |
| initiator (B) | | |
| Type | Irgacure | Irgacure |
| | 379 | 379 |
| Absorption local | 321 | 321 |
| maximum wavelength | | |
| λ_{b1} (nm) | | |
| Molar absorption | 25411 | 25411 |
| coefficient (cm²/mol) | | |
| Average molar | 19412 | 19412 |
| absorption coefficient | | |
| (cm²/mol) | | |
| Number of parts added | 4 | 4 |
| Phase difference film | | |
| properties | | |
| Δn0 | 0.0648 | 0.0648 |
| Δn1 | 0.0648 | 0.0648 |
| Δn0 − Δn1 | 0.0000 | 0.0000 |
| Re (nm) | 143 | 143 |
| Production conditions | | |
| UV irradiation condition | 700 mJ/cm² | 700 mJ/cm² |
| Heating treatment | No | No |
| condition | | |
| Re change rate ΔRe | −8.2% | −7.9% |

In Tables 4 and 5 below, “A-TMPT”, “ATM-4E”, “A-DOG”, “A-TMM3L”, “A-TMPT-3E0”, and “A-BPE-20” represents “NK Ester A-TMPT”, “NK Ester ATM-4E”, “NK Ester A-DOG”, “NK Ester A-TMM3L”, “NK Ester A-TMPT-3E0”, and “NK ester A-BPE-20”, respectively, which are manufactured by Shin-Nakamura Chemical Co., Ltd.

“A-TMPT”, “ATM-4E”, “A-DOG”, “A-TMM3L”, “A-TMPT-3EO”, and “A-BPE-20” are compounds respectively represented by the following formulae.

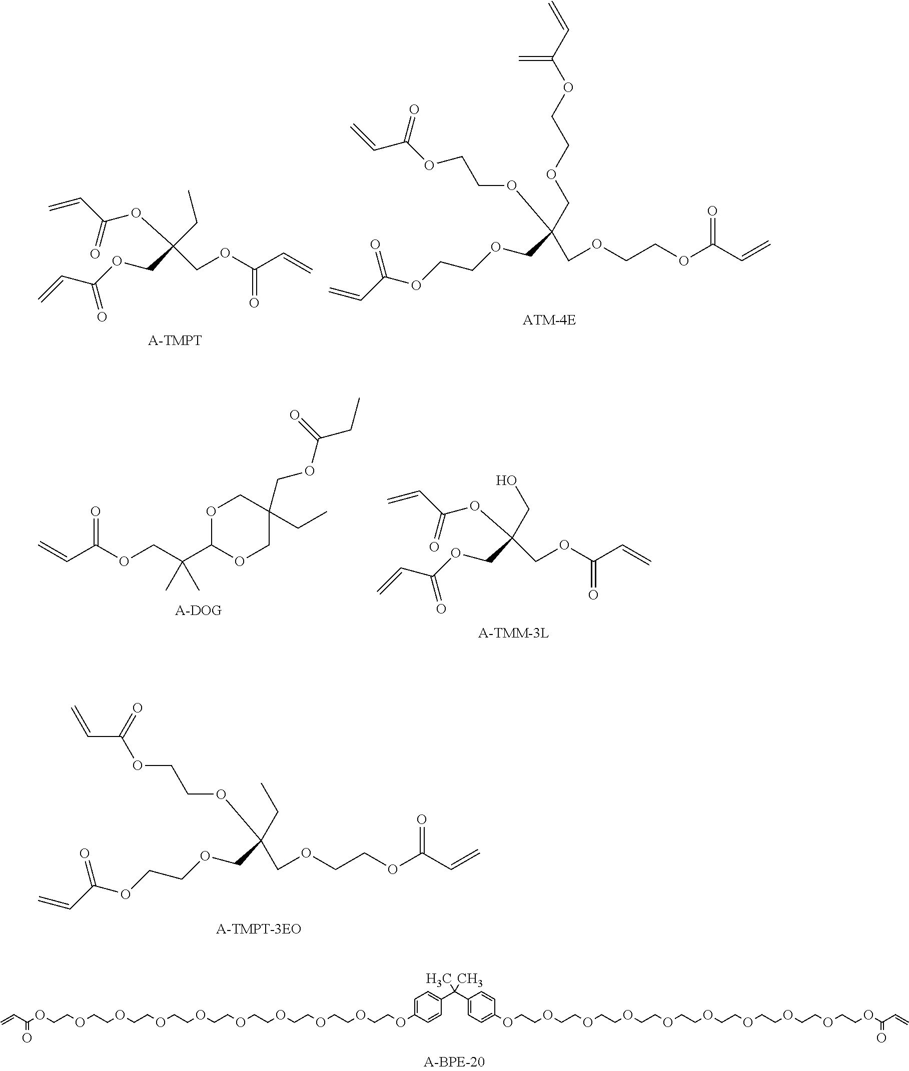

TABLE 4

| | Ex. 9 | Ex. 10 | Ex. 11 | Ex. 12 |
|---|---|---|---|---|
| Polymerizable liquid | | | | |
| crystal compound (A) | | | | |
| Type | A-2 | A-2 | A-2 | A-2 |
| Crosslinking agent (C) | | | | |
| Type | A-DCP | A-TMPT | ATM-4E | A-DOG |
| Number of functional | 2 | 3 | 4 | 2 |
| groups | | | | |
| Absorption local | 217 | 237 | 238 | 227 |
| maximum wavelength | | | | |
| λ_{c1} (nm) | | | | |
| Viscosity (mPa · s) | 120 | 110 | 150 | 310 |
| Number of parts added | 10 | 10 | 10 | 10 |
| Photopolymerization | | | | |
| initiator (B) | | | | |
| Type | NCI-730 | NCI-730 | NCI-730 | NCI-730 |
| Number of parts added | 4 | 4 | 4 | 8 |
| Re change rate | −3.1% | −3.6% | −1.4% | −2.9% |
| ΔRe (500 hr) | | | | |
| Oriented surface state | A | A | B | A |

TABLE 5

| | Ex. 13 | Ex. 14 | Ex. 15 |
|---|---|---|---|
| Polymerizable liquid | | | |
| crystal compound (A) | | | |
| Type | A-2 | A-2 | A-2 |
| Crosslinking agent (C) | | | |
| Type | A-TMM3L | A-TMPT-3EO | A-BPE-20 |
| Number of functional | 3 | 3 | 2 |
| groups | | | |
| Absorption local | 238 | 230 | 235 |
| maximum wavelength | | | |
| λ_{c1} (nm) | | | |
| Viscosity (mPa · s) | 490 | 60 | 700 |
| Number of parts added | 10 | 10 | 10 |
| Photopolymerization | | | |
| initiator (B) | | | |
| Type | NCI-730 | NCI-730 | NCI-730 |
| Number of parts added | 4 | 4 | 4 |
| Re change rate | −1.4% | −1.3% | −1.6% |
| ΔRe (500 hr) | | | |
| Oriented surface state | B | C | C |

As understood from the aforementioned results, the phase difference film produced with the composition of each Example showed a smaller absolute value of a change rate of Re than the phase difference film produced with the composition of each of Comparative Example 1 and Comparative Example 2 which do not satisfy the formula (i): |λₐ₁−λ_{b1}|≤20 nm.

It is also understood that the phase difference film according to Example 8 in which heating treatment was performed shows a smaller absolute value of a change rate of Re than the phase difference film according to Example 3 in which heating treatment was not performed.

These results illustrate that: a phase difference film showing a small absolute value of a change rate of a retardation Re before and after a thermal durability test can be produced with the composition of the present invention; the phase difference film of the present invention shows a small absolute value of a change rate of a retardation Re before and after a thermal durability test; and the phase difference film showing a small absolute value of a change rate of a retardation Re before and after a thermal durability test can be produced by the method for producing the phase difference film of the present invention.

1. A composition comprising a polymerizable liquid crystal compound (A), a photopolymerization initiator (B), and a crosslinking agent (C),
the composition satisfying the following formulae (i) and (ii):

|λₐ₁−λ_{b1}|≤20 nm (i), and
λ_{c1}≤250 nm (ii)
(in the formulae,
λₐ₁ represents a wavelength of an absorption local maximum that is the longest one of wavelengths of absorption local maxima in a light absorption spectrum of 200 nm or more and 500 nm or less of the polymerizable liquid crystal compound (A),
λ_{b1} represents a wavelength of an absorption local maximum that is the longest one of wavelengths of absorption local maxima in a light absorption spectrum of 200 nm or more and 500 nm or less of the photopolymerization initiator (B), and
λ_{c1} represents a wavelength of at least one absorption local maximum in a light absorption spectrum of 200 nm or more and 500 nm or less of the crosslinking agent (C)).

2. The composition according to claim 1, further satisfying the following formulae (iii) and (iv):
300 nm≤λ₁≤355 nm (iii), and
5000 cm²/mol≤Aₐ≤25000 cm²/mol (iv)
(in the formulae,
λₐ₁ has the same meaning as the above, and
Aₐ represents an average molar absorption coefficient of the polymerizable liquid crystal compound (A) in a range of 300 nm or more and 355 nm or less).

3. The composition according to claim 1, further satisfying the following formulae (v) and (vi):
300 nm≤λ_{b1}≤355 nm (v), and
10000 cm²/mol≤A_{b}≤25000 cm²/mol (iv)
(in the formulae,
λ_{b1} has the same meaning as the above, and
A_{b} represents an average molar absorption coefficient of the photopolymerization initiator (B) in a range of 300 nm or more and 355 nm or less).

4. The composition according to claim 1, further satisfying the following formula (vii):
A_{c}<Aₐ and A_{c}<A_{b} (vii)
(in the formula,
Aₐ represents an average molar absorption coefficient (cm²/mol) of the polymerizable liquid crystal compound (A) in a range of 300 nm or more and 355 nm or less,
A_{b} represents an average molar absorption coefficient (cm²/mol) of the photopolymerization initiator (B) in a range of 300 nm or more and 355 nm or less, and
A_{c} represents an average molar absorption coefficient (cm²/mol) of the crosslinking agent (C) in a range of 300 nm or more and 355 nm or less).

5. The composition according to claim 1, wherein the polymerizable liquid crystal compound (A) is a compound represented by the following formula (I): 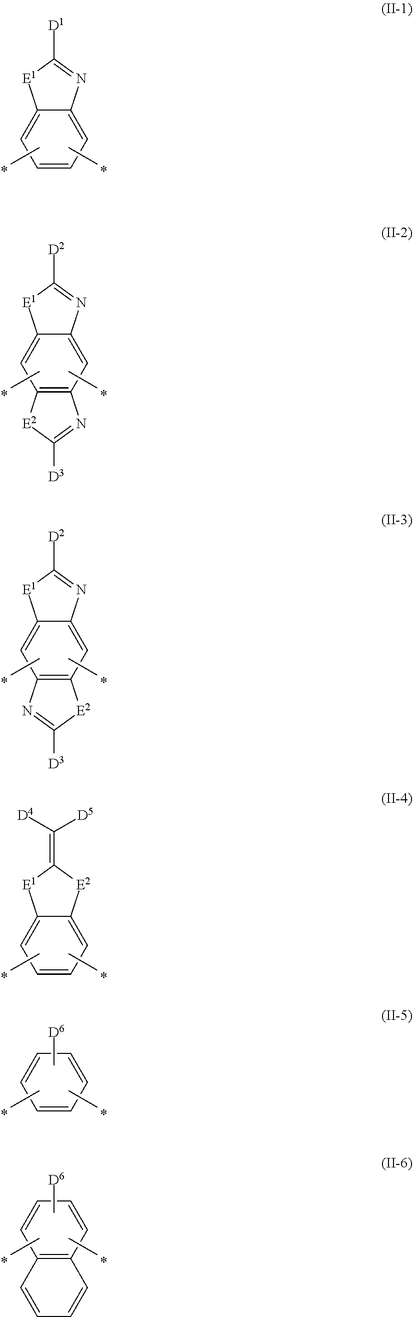 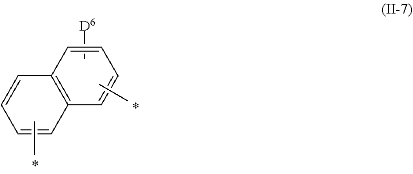
(in the formula (I),
Ar is a group represented by any of the following formulae (II-1) to (II-7), 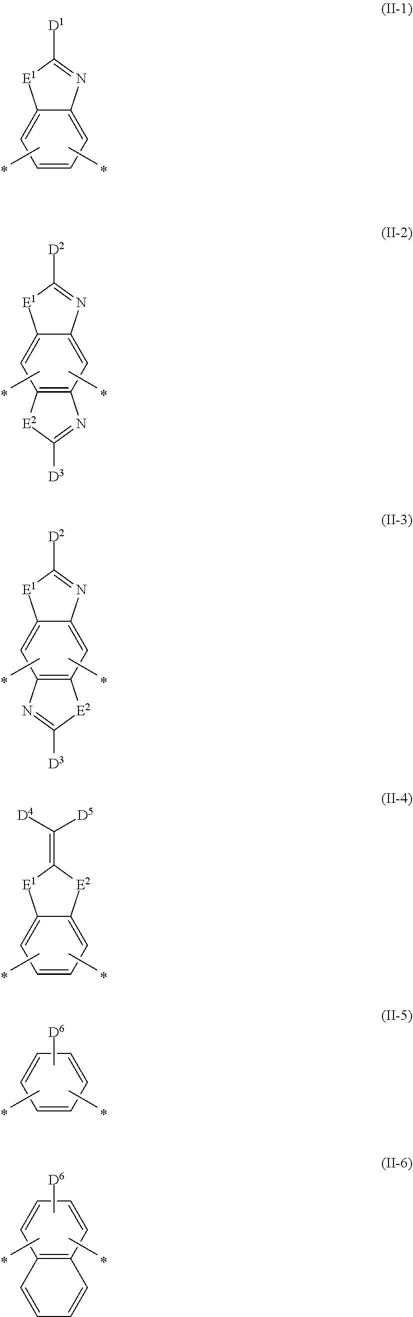 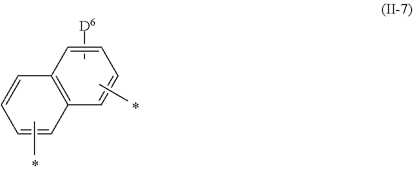
(in the formulae (II-1) to (II-7),
the symbol “*” represents a position for bonding with Z¹ or Z²,
each of E¹ and E² independently represents a group selected from the group consisting of —CR¹¹R¹², —S—, —NR¹¹—, —CO—, and —O—, and each of R¹¹ and R¹² independently represents a hydrogen atom or an alkyl group of 1 to 4 carbon atoms,
each of D¹ to D³ independently represents an aromatic hydrocarbon ring group optionally having a substituent or an aromatic heterocyclic ring group optionally having a substituent,
each of D⁴ to D⁵ independently represents a non-cyclic group optionally having a substituent, and D⁴ and D⁵ may together form a ring,
D⁶ represents a group selected from the group consisting of —C(R^{f})═N—N(R^{g})R^{h}, —C(R^{f})═N—N═C(R^{g})R^{h}, and —C(R^{f})═N—N═Rⁱ, R^{f} represents a group selected from the group consisting of a hydrogen atom and an alkyl group of 1 to 6 carbon atoms, R^{g} represents a group selected from the group consisting of a hydrogen atom and an organic group of 1 to 30 carbon atoms optionally having a substituent, R^{h} represents an organic group having one or more aromatic rings selected from the group consisting of an aromatic hydrocarbon ring of 6 to 30 carbon atoms and an aromatic heterocyclic ring of 2 to 30 carbon atoms, and Rⁱ represents an organic group having one or more aromatic rings selected from the group consisting of an aromatic hydrocarbon ring of 6 to 30 carbon atoms and an aromatic heterocyclic ring of 2 to 30 carbon atoms),
each of Z¹ and Z² independently represents one selected from the group consisting of a single bond, —O—, —O—CH₂—, —CH₂—O—, —O—CH₂—CH₂—, —CH₂—CH₂—O—, —C(═O)—O—, —O—C(═O)—, —C(═O)—S—, —S—C(═O)—, —NR²¹—C(═O)—, —C(═O)—NR²¹—, —CF₂—O—, —O—CF₂—, —CH₂—CH₂—, —CF₂—CF₂—, —O—CH₂—CH₂—O—, —CH═CH—C(═O)—O—, —O—C(═O)—CH═CH—, —CH₂—C(═O)—O—, —O—C(═O)—CH₂—, —CH₂—O—C(═O)—, —C(═O)—O—CH₂—, —CH₂—CH₂—C(═O)—O—, —O—C(═O)—CH₂—CH₂—, —CH₂—CH₂—O—C(═O)—, —C(═O)—O—CH₂—CH₂—, —CH═CH—, —N═CH—, —CH═N—, —N═C(CH₃)—, —C(CH₃)═N—, —N═N—, and —C≡C—, and each of R²¹'s independently represents a hydrogen atom or an alkyl group of 1 to 6 carbon atoms,
each of A¹, A², B¹, and B² independently represents a group selected from the group consisting of a cyclic aliphatic group optionally having a substituent, and an aromatic group optionally having a substituent,
each of Y¹ to Y⁴ independently represents one selected from the group consisting of a single bond, —O—, —C(═O)—, —C(═O)—O—, —O—C(═O)—, —NR²²—C(═O)—, —C(═O)—NR²²—, —O—C(═O)—O—, —NR²²—C(═O)—O—, —O—C(═O)—NR²²—, and —NR²²—C(═O)—NR²³—, and each of R²² and R²³ independently represents a hydrogen atom or an alkyl group of 1 to 6 carbon atoms,
each of G¹ and G² independently represents an organic group selected from the group consisting of an aliphatic hydrocarbon group of 1 to 20 carbon atoms; and a group having a structure obtained by substituting one or more of methylene groups (—CH₂—) contained in an aliphatic hydrocarbon group of 3 to 20 carbon atoms with —O— or —C(═O)—, wherein a hydrogen atom contained in the organic group of G¹ and G² may be substituted with an alkyl group of 1 to 5 carbon atoms, an alkoxy group of 1 to 5 carbon atoms, or a halogen atom, provided that methylene groups (—CH₂—) at both ends of G¹ and G² are never substituted with —O— or —C(═O)—,
each of P¹ and P² independently represents a polymerizable functional group, and
each of p and q independently represents 0 or 1).

6. The composition according to claim 1, wherein the polymerizable liquid crystal compound (A) is a polymerizable liquid crystal compound having a reverse wavelength dispersion property.

7. The composition according to claim 1, wherein the crosslinking agent (C) is a bifunctional monomer.

8. The composition according to claim 1, wherein the crosslinking agent (C) is a compound having an alicyclic structure.

9. The composition according to claim 1, wherein the photopolymerization initiator (B) is an O-acyloxime compound.

10. A phase difference film formed of a cured product of a composition (X) that is the composition according to claim 1, wherein a retardation Re at 590 nm thereof is more than 100 nm and less than 180 nm.

11. The phase difference film according to claim 10, satisfying the following formula (viii):

|Δn0−Δn1|≤0.025 nm (viii)
(in the formula,
Δn1 represents a birefringence at 590 nm of the phase difference film, and
Δn0 represents a birefringence at 590 nm of a film formed of a cured product of a composition (X₀) that is a composition omitting the crosslinking agent (C) from the composition (X).

12. A method for producing a phase difference film formed of a cured product of the composition according to claim 1, comprising the following steps (1) to (3) in this order:
step (1): a step of drying a composition layer formed of the composition according to claim 1;
step (2): a step of irradiating the dried composition layer with ultraviolet light to obtain a cured layer; and
step (3): a step of subjecting the cured layer to a heating treatment.

13. The method for producing a phase difference film according to claim 12, wherein the step (2) includes irradiating with ultraviolet light by a mercury lamp.
